(19) United States
(12) Patent Application Publication
(10) Pub. No.: US 2025/0317854 A1
(43) Pub. Date: Oct. 9, 2025

(54) WAKE UP SIGNAL (WUS) AND ON-DEMAND SYSTEM INFORMATION

(71) Applicant: QUALCOMM Incorporated, San Diego, CA (US)

(72) Inventors: Sherif ELAZZOUNI, San Diego, CA (US); Hung Dinh LY, San Diego, CA (US); Qing LI, Princeton Junction, NJ (US); Navid ABEDINI, Basking Ridge, NJ (US); Wanshi CHEN, San Diego, CA (US)

(21) Appl. No.: 18/629,861

(22) Filed: Apr. 8, 2024

(51) Int. Cl. H04W 52/02; H04W 74/0833

(52) U.S. Cl. CPC H04W 52/0235; H04W 74/0833

(57) ABSTRACT

Certain aspects of the present disclosure provide techniques for wireless communications by an apparatus. A method includes sending a wake up signal (WUS), the WUS comprising: an indication of one or more applicable features of the apparatus, the one or more applicable features associated with random access configuration; and an indication of a request for system information; and receiving, after the WUS is sent, the system information.

### INTRODUCTION

### Field of the Disclosure

Aspects of the present disclosure relate to wireless communications, and more particularly, to techniques for system information communication.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes sending a wake up signal (WUS), the WUS comprising: an indication of one or more applicable features of the apparatus, the one or more applicable features associated with random access configuration; and an indication of a request for system information; and receiving, after the WUS is sent, the system information.

Another aspect provides a method for wireless communications by an apparatus. The method includes sending, in a time period, a WUS, wherein the WUS is based on a WUS preamble, the WUS comprising an indication of a request for system information; and receiving, after the WUS is sent, the system information, the system information comprising: an indication of one or more random access configurations; and an indication of an association between a first random access configuration, of the one or more random access configurations, and a combination of a first WUS preamble and a first time period.

Another aspect provides a method for wireless communications by an apparatus. The method includes receiving a WUS, the WUS comprising: an indication of one or more applicable features of a user equipment (UE), the one or more applicable features associated with random access configuration; and an indication of a request for system information; and sending, after the WUS is received, the system information.

Another aspect provides a method for wireless communications by an apparatus. The method includes receiving, in a time period, a WUS, wherein the WUS is based on a WUS preamble, the WUS comprising an indication of a request for system information; and receiving, after the WUS is sent, the system information, the system information comprising: an indication of one or more random access configurations; and an indication of an association between a first random access configuration, of the one or more random access configurations, and a combination of a first WUS preamble and a first time period.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5A depicts a process flow diagram of an example four-step random access procedure performed between a UE and a network entity.

FIG. 5B depicts a process flow diagram of an example two-step random access procedure performed between a UE and a network entity.

FIG. 6 depicts a process flow diagram of an example on-demand system information procedure performed between a UE and a network entity.

FIG. 7 illustrates example applicable features.

FIG. 8 illustrates an example of a plurality of random access configurations and sets of applicable features associated with random access configurations that may be included in system information.

FIG. 9 depicts a process flow diagram of an example on-demand system information procedure performed between a UE and a network entity.

FIG. 10 depicts a process flow diagram of an example on-demand system information procedure performed between multiple UEs and a network entity.

FIG. 11 illustrates two example random access configurations that may be included in system information.

FIG. 12 depicts a process flow diagram of an example on-demand system information procedure performed between a UE and a network entity.

FIG. 13 depicts a method for wireless communications.

FIG. 14 depicts another method for wireless communications.

FIG. 15 depicts another method for wireless communications.

FIG. 16 depicts another method for wireless communications.

FIG. 17 depicts aspects of an example communications device.

FIG. 18 depicts aspects of an example communications device.

FIG. 19 depicts aspects of an example communications device.

FIG. 20 depicts aspects of an example communications device.

### DETAILED DESCRIPTION

Aspects of the present disclosure provide apparatuses, methods, processing systems, and computer-readable mediums for on-demand system information (e.g., system information block (SIB), such as SIB1) communication in response to a wake up signal (WUS).

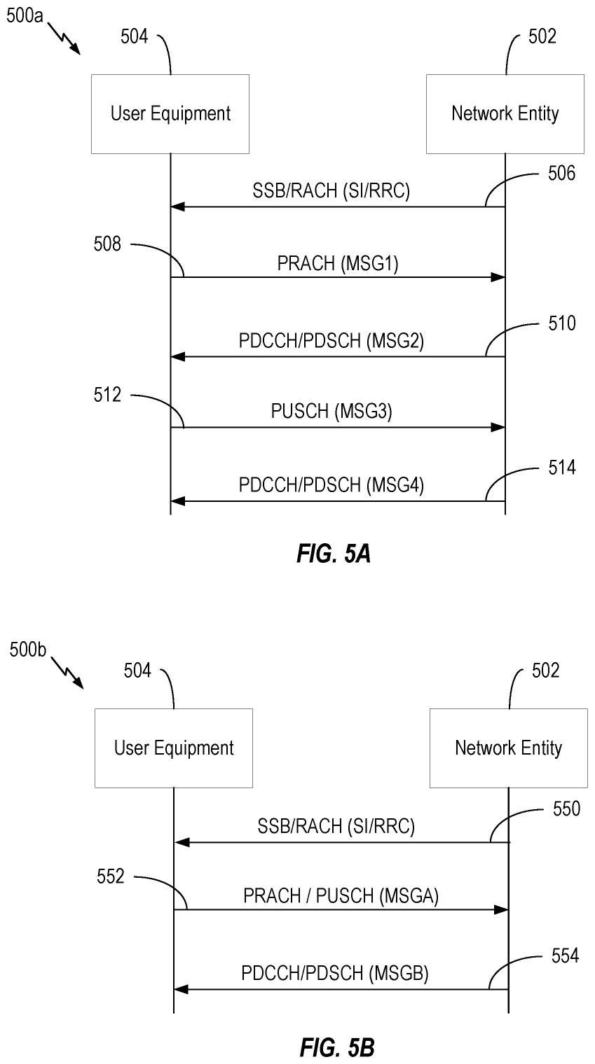

In certain wireless communication systems (e.g., 5G New Radio systems and/or any future wireless communications system), a user equipment (UE) may communicate with a network entity (e.g., a base station) using a random access procedure, for example, for initial access to the network entity, for beam failure recovery, to obtain timing information (e.g., a timing advance), to request uplink communication resources, to request system information, etc. An example random access procedure may begin with the UE sending to the network entity a random access preamble, such as on a random access channel (RACH) (e.g., a physical random access channel (PRACH)), in a random access occasion (RO), which may include one or more time-frequency resources. Upon successful reception of the preamble, the network entity sends, to the UE, a response to the preamble in a random access response (RAR) window. The response may include an uplink scheduling grant. On receiving the response, the UE may send a request to setup a connection with the network entity, and then, the network entity may reply with a contention resolution response. Certain aspects associated with random access communications are further described herein, for example, with respect to FIGS. 5A and 5B.

In some cases, a UE may use system information to perform a random access procedure. For example, a UE may receive, from the network entity, system information (e.g., SIB1) including an indication of one or more random access configurations that may indicate one or more random access preambles and/or one or more ROs available for the UE to perform a random access procedure. In some cases, a network entity is configured to broadcast such system information, such that all UEs receive the same system information. For example, the network entity may periodically broadcast the system information, such that a UE can receive the system information and use the system information to perform random access procedure(s) with the network entity.

In certain aspects, as used herein, an “indication” of X (e.g., one or more random access configurations) may refer to data that maps to X, such as one or more index values or preambles that map to X using a separate mapping that may be stored at the devices communicating the indication. In another example, an “indication” of X may refer to data that explicitly provides X, such as without a separate mapping being needed.

In some cases, different UEs may support different features associated with random access configuration of the UE (also referred to as applicable features of the UE or apparatus). In certain aspects, the features are associated with random access configuration, in that they may affect a random access configuration assigned to the UE, as further discussed herein, such as by different feature sets being associated with different random access configurations. For example, a given UE may support one or more applicable features, such as one or more of reduced capability, small data, enhanced reduced capability, network access stratum (AS) group, message 3 (msg3) repetition, message 1 (msg1) repetition, and/or the like.

In certain aspects, different random access configurations, such as indicated in the system information, may be associated with different sets of applicable features (e.g., where a “set of X” refers to “one or more of X”). For example, a first random access configuration may be associated with a first set of applicable features, while a second random access configuration may be associated with a second set of applicable features. Associating different random access configurations with different sets of applicable features may help to divide assignment of random access preambles and ROs among different sets of UEs, which may reduce the chance of collisions between UEs when performing random access, as in different UEs selecting the same RO and random access preamble to perform random access at the same time. For example, a UE may determine a random access configuration is associated with the UE based on the set of applicable features associated with the random access configuration and the one or more applicable features of the UE. For example, the UE may determine to use a random access configuration associated with a particular set of applicable features, when the UE supports one or more (e.g., all or a subset (less than all)) of the applicable features of the set of applicable features.

One technical problem with associating different random access configurations with different sets of applicable features in system information is that, to carry the information associating different random access configurations with different sets of applicable features, the system information may become large and require significant resources and overhead to communicate, including time-frequency resources and processing resources at the network entity and UE. For example, the system information may carry an indication of a large number (e.g., 64) of random access configurations, and information associating each random access configuration with a particular set of applicable features. Some sets of applicable features may be associated with one or multiple random access configurations. Some sets of applicable features may not be indicated in the system information.

Another technical problem is that if the system information is communicated periodically, there may be significant resources and overhead to communicate the system information, even during periods where no UEs need to receive the system information from the network entity.

One technical solution to the problem of periodic communication of system information by the network entity, even when no UE may need the system information from the network entity, is to provide for on-demand communication of system information, which may be aperiodic instead of periodic. For example, in certain aspects, a UE may be configured to transmit a WUS to the network entity (e.g., on a RACH), where the WUS requests system information from the network entity. Accordingly, the network entity, in response to the WUS, may send (e.g., broadcast) the system information. Therefore, the network entity may only send system information when there is a UE that may need to receive the system information, thus reducing resources and overhead to communicate system information.

Certain aspects herein further overcome the technical problem of resources and overhead to communicate system information by reducing the amount of information carried in the system information. This may provide the technical benefit of reduced resources and overhead to communicate system information.

For example, in certain aspects, the WUS sent by a UE to a network entity requesting system information may indicate both a request for system information and indicate one or more applicable features of the UE. In certain aspects, the WUS includes (e.g., only) a WUS preamble and the preamble itself indicates (e.g., maps to) a request for system information and/or the one or more applicable features of the UE. In certain aspects, the WUS includes a WUS preamble, and additional information (e.g., bits) that indicate a request for system information and/or the one or more applicable features of the UE.

In certain aspects, in response to the WUS, the network entity is configured to send to the UE, system information. In certain aspects, the system information, instead of including an indication of all random access configurations of the network entity, may include only one or more random access configurations associated with the one or more applicable features of the UE as indicated in the WUS and/or a default or common random access configuration that may be agnostic of applicable features, meaning it may be for any UE. Accordingly, a UE receiving the system information, may determine that the UE can use for random access a random access configuration associated with one or more applicable features of the UE. Thus, the size of the system information may be reduced, thereby reducing resources and overhead to communicate system information. Accordingly, a technical benefit of a UE indicating in WUS one or more applicable features of the UE may be reduced overhead to communicate system information.

In certain aspects, a network entity may receive WUS from multiple UEs (e.g., within a time period, also referred to as a time window), each WUS indicating one or more applicable features of the UE sending the WUS. In certain aspects, in response to the WUS from multiple UEs, the network entity is configured to send to the multiple UEs, system information (e.g., one system information to the multiple UEs). In certain aspects, the system information, instead of including an indication of all random access configurations of the network entity, may include one or more random access configurations, where each of the one or more random access configurations is associated with one or more applicable features of at least one of the UEs and/or a default or common random access configuration. Accordingly, the network entity may still send a reduced size system information, but include random access configuration(s) for each of the multiple UEs, further providing communication resource efficiency, such as over sending separate system information to each of the multiple UEs. For example, the system information may include a first random access configuration associated with one or more applicable features of a first UE, and a second random access configuration associated with one or more applicable features of a second UE. In certain aspects, the first random access configuration and/or second random access configuration may additionally be associated with one or more additional UEs.

As another example, in certain aspects, the WUS sent by a UE to a network entity requesting system information, may be based on a WUS preamble, which may mean that the WUS includes (e.g., only) the WUS preamble itself, or includes the WUS preamble along with one or more additional bits. In certain aspects, the WUS indicates a request for system information, and may be sent in a particular time period.

In certain aspects, in response to the WUS, the network entity is configured to send to the UE, system information. In certain aspects, the system information, instead of including an indication of all random access configurations of the network entity, may include only one or more random access configurations associated with the WUS preamble and the time period the WUS was sent and/or a default or common random access configuration. In certain aspects, the system information, for one or more random access configurations indicated in the system information, further includes an indication of an association between each of the one or more random access configurations and a combination of a WUS preamble and a time period of communication of a WUS. Accordingly, a UE receiving the system information, may determine that the UE can use for random access a random access configuration associated with the WUS preamble sent by the UE and the time period at which the UE sent the WUS. Accordingly, the size of the system information may be reduced, thereby reducing resources and overhead to communicate system information.

In certain aspects, a network entity may receive WUS from multiple UEs (e.g., within a longer time period, also referred to as a time window), each WUS being based on a respective WUS preamble and sent at a respective time, where different UEs may end up using the same or different WUS preambles and may send the WUS at the same or different times. In certain aspects, in response to the WUS from multiple UEs, the network entity is configured to send to the multiple UEs, system information (e.g., one system information to the multiple UEs). In certain aspects, the system information, instead of including an indication of all random access configurations of the network entity, may include one or more random access configurations, where each of the one or more random access configurations is associated with a combination of a WUS preamble used by at least one of the UEs and the time period at which the at least one of the UEs sent the WUS, and/or a default or common random access configuration. Accordingly, the network entity may still send a reduced size system information, but include random access configuration(s) for each of the multiple UEs, further providing communication resource efficiency, such as over sending separate system information to each of the multiple UEs.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

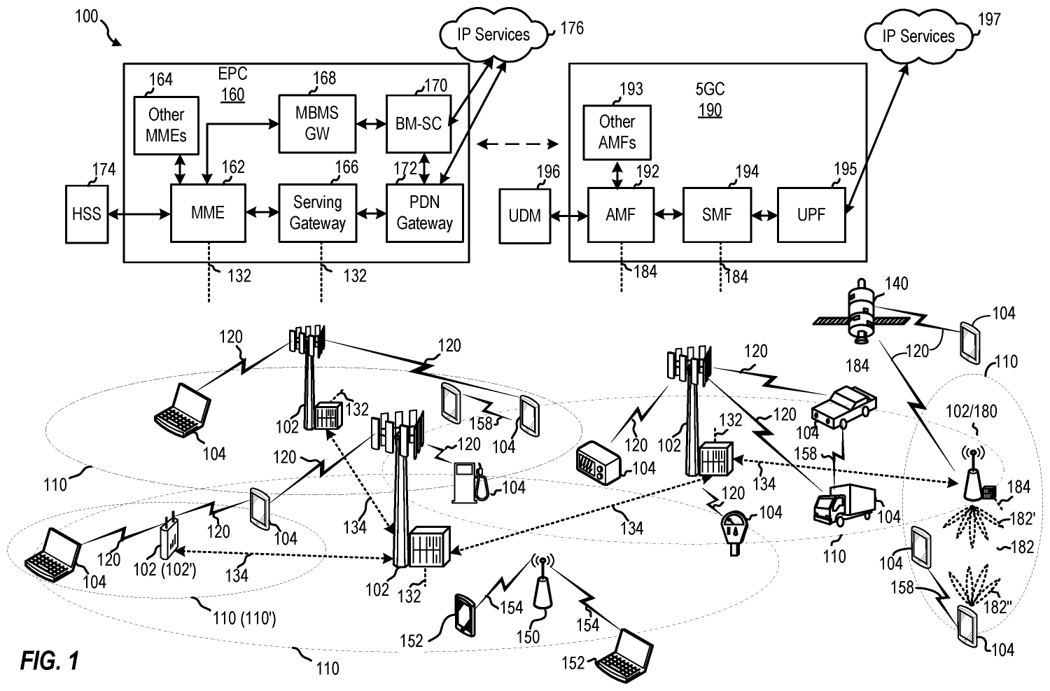

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others. BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

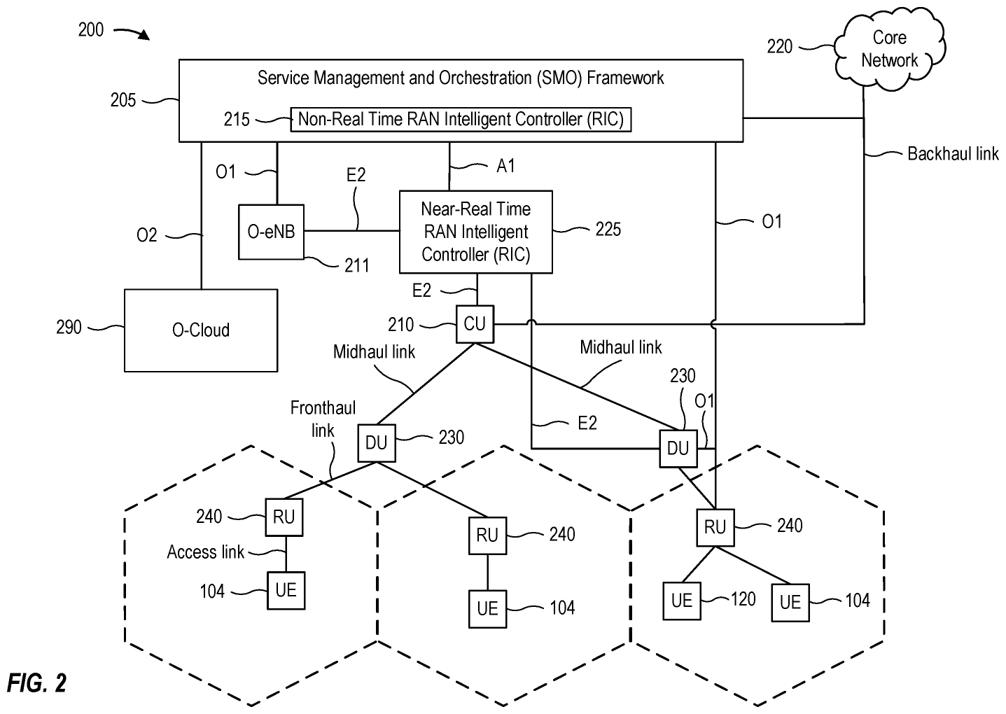

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

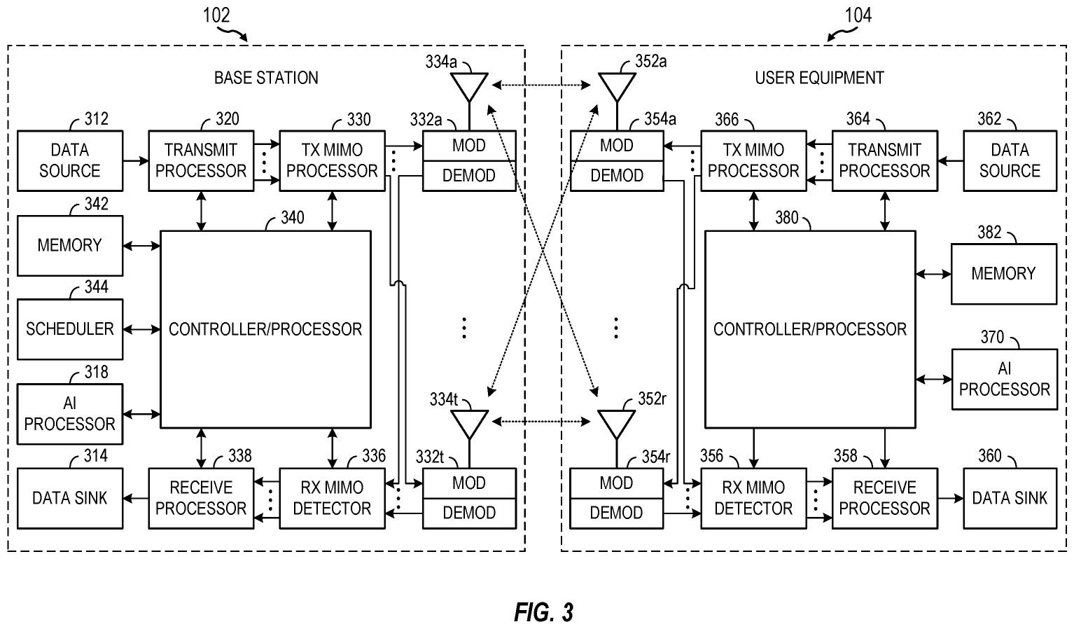

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

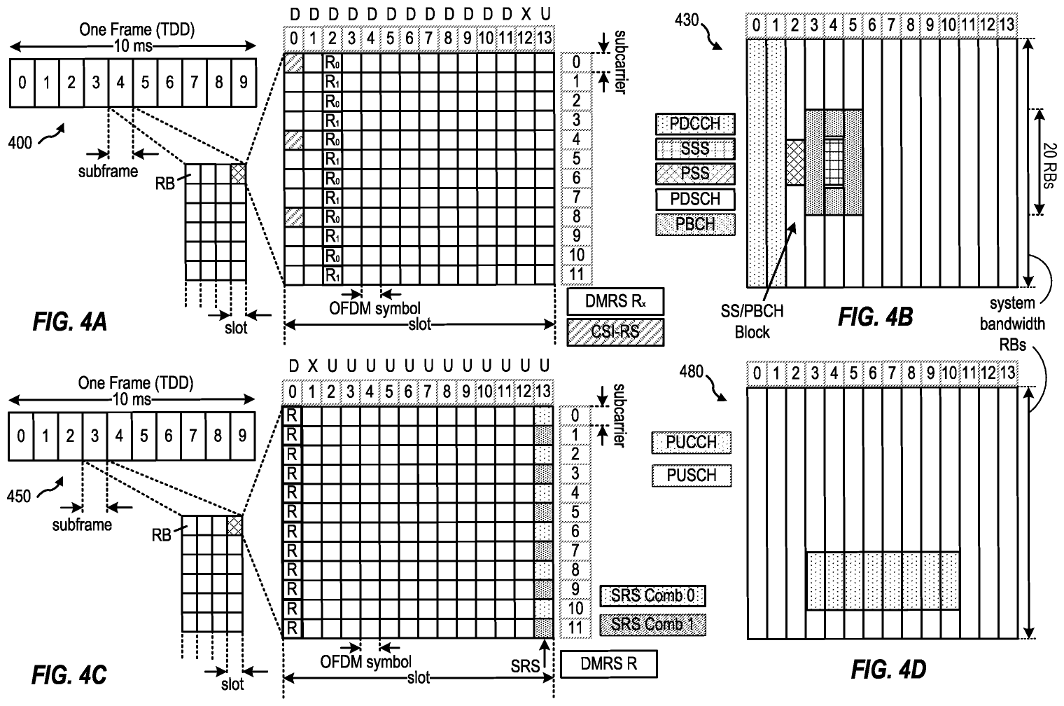

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 24×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Random Access Procedures

Certain wireless communication systems (e.g., a 5G NR system and/or any future wireless communications system) may provide a specified channel for random access, such as a random access channel (RACH), and corresponding random access procedure(s). As discussed above, random access procedure may be performed for any of various events including, for example, initial access from an idle state (e.g., RRC idle), RRC connection re-establishment, handover, downlink (DL) and/or uplink (UL) data arrival (e.g., when the UE is in an idle state), or device positioning.

FIG. 5A depicts a process flow diagram of an example four-step RACH procedure 500a performed between a UE 504 and a network entity 502. In some aspects, the UE 504 is the UE 104 depicted and described with respect to FIGS. 1 and 3, and the network entity 502 is the base station 102 depicted and described with respect to FIGS. 1 and 3 or a disaggregated base station depicted and described with respect to FIG. 2.

The RACH procedure 500a may optionally begin at 506, where the network entity 502 broadcasts and the UE 504 receives a random access configuration, for example, in system information (S1) within a synchronization signal block (SSB), or within an RRC message. The random access configuration may indicate or include one or more parameters for random access communications, such as defining the RACH, the total number of random access preambles (e.g., preamble sequences) available for random access, power ramping parameters, response window size (duration), one or more ROs, etc.

At 508, the UE 504 sends a first message (MSG1 or message 1) to the network entity 502 on a physical random access channel (PRACH). In some cases, a PRACH may be referred to as a RACH. In certain aspects, MSG1 may indicate or include a RACH preamble. The RACH preamble may be or include a preamble sequence (e.g., a Zaddoff Chu sequence). For contention-based random access, the preamble sequence may be randomly selected among a set of preamble sequences (e.g., up to 64 sequences, in some cases). The preamble sequence may be used to identify the UE 504 for scheduling communications (e.g., MSG2 (message 2) and MSG3 (message 3)) with the network entity. In certain aspects, terms such as “RACH preamble,” “random access preamble,” “preamble,” “preamble sequence,” “sequence,” and the like may be used interchangeably.

At 510, the network entity 502 may respond with a random access response (RAR) message (MSG2). For example, the network entity 502 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble sequence and indicate that the RAR is for the UE 504 that transmitted MSG1 at 506. For example, the RAPID may be the preamble sequence itself, or may be based on (e.g., a function or mapping) of the preamble sequence. The backoff parameter value may be used to determine a random access (e.g., RACH) occasion (RO) for sending a subsequent RACH transmission (e.g., a preamble transmission). A RACH occasion may correspond to one or more time-frequency resources available for transmitting a preamble in a RACH.

At 512, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (for an UL transmission). As an example, MSG3 is communicated in the time-frequency resource(s) indicated in the UL grant of the RAR.

At 514, the network entity 502 may send a contention resolution message (MSG4 or message 4) in response to MSG3. The network entity 502 may send a downlink scheduling command (e.g., DCI), which is addressed to a specific UE identity associated with the UE 504, via the PDCCH. The network entity 502 may send a UE contention resolution identity (e.g., a medium access control element) via the PDSCH according to the downlink scheduling command. In certain cases, multiple UEs may send the same preamble in the same RO. As the network entity 502 may not be able to identify which UE sent which preamble, the network entity 502 may reply with a single RAR associated with the preamble. The MSG3 may include or indicate a specific UE identity associated with the UE 504, such as a radio network temporary identifier (RNTI) or a temporary mobile subscriber identity (TMSI). The network entity 502 may decode MSG3 and determine the UE identity associated with at least one of the UEs (e.g., UE 504). MSG4 may be addressed to the UE identity (e.g., the RNTI or an RNTI based on the TMSI) associated with the MSG3 that the network entity was able to successfully decode. For example, the MSG4 may be scrambled by the RNTI associated with the MSG3. If the UE 504 obtains the same identity sent in MSG3, the UE 504 concludes that the random access procedure succeeded. In some cases, if the UE 504 is unable to obtain or decode MSG3 and/or MSG4, the UE 504 may repeat the RACH procedure, such as the four-step RACH procedure 500a.

In some cases, to reduce the latency associated with random access, a two-step RACH procedure may be used. As the name implies, the two-step RACH procedure may effectively consolidate the four messages of the four-step RACH procedure into two messages.

FIG. 5B depicts a process flow diagram of an example two-step RACH procedure 500b performed between the UE 504 and the network entity 502.

The procedure 500b may optionally begin at 550, where the network entity 502 broadcasts and the UE 504 receives a random access configuration, for example in system information within a synchronization signal block, or within an RRC message.

At 552, the UE 504 sends a first message (MSGA or message A) to the network entity 502, which may effectively combine MSG1 and MSG3 described above with respect to FIG. 5A. In some aspects, MSGA includes a RACH preamble for random access and a payload. For example, the payload may include a UE-ID and other signaling information, such as a buffer status report or scheduling request. The RACH preamble of MSGA may be transmitted over the PRACH, and the payload of MSGA may be transmitted over the PUSCH, for example.

At 554, the network entity 502 may send a random access response message (MSGB or message B), which may effectively combine MSG2 and MSG4 described above, via the PDCCH and PDSCH. For example, MSGB may include a RAPID, a timing advance, a backoff parameter value, a contention resolution message, an uplink and/or downlink grant, and transmit power control commands.

### Aspects Related to Wake Up Signal Based On-Demand System Information

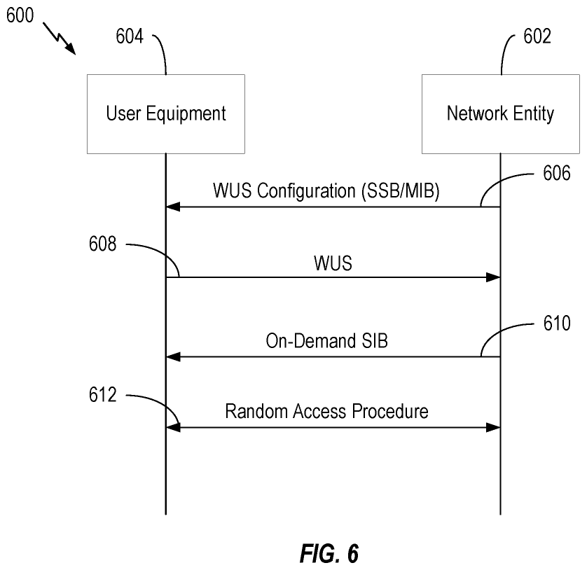

FIG. 6 depicts a process flow diagram of an example on-demand system information procedure 600 performed between a UE 604 and a network entity 602. In some aspects, the UE 604 is the UE 104 depicted and described with respect to FIGS. 1 and 3, and the network entity 602 is the base station 102 depicted and described with respect to FIGS. 1 and 3 or a disaggregated base station depicted and described with respect to FIG. 2.

At 606, network entity 602 sends to UE 604 an indication of a WUS configuration. The WUS configuration includes an indication of one or more WUS preambles available for communication of WUS and an indication of one or more time frequency resources available for communication of WUS. For example, the network entity 602 may send (e.g., broadcast) a master information block (MIB), such as in a SSB, including the indication of the WUS configuration.

At 608, UE 604 sends to network entity 602 a WUS, such as on a RACH, requesting system information (e.g., SIB1) (e.g., system information including one or more random access configurations for UE 604 to perform a random access procedure). In certain aspects, the WUS is based on a WUS preamble of the one or more WUS preambles indicated in the WUS configuration. For example, UE 604 may randomly select one of the one or more WUS preambles indicated in the WUS configuration.

At 610, after 608, such as in response to the WUS received at 608, network entity 602 sends, to UE 604, system information (e.g., SIB1). The system information may be referred to as on-demand system information as in it may be sent based on the WUS requesting the system information. The system information may be broadcast or sent to multiple UEs, such as where multiple UEs request the system information, such as within a time window. In certain aspects, the system information may indicate one or more random access configurations (e.g., all random access configurations supported by network entity 602).

At 612, UE 604 and network entity 602 may perform a random access procedure, such as a four-step RACH procedure or a two-step RACH procedure. For example, UE 604 may send a RACH preamble selected from a random access configuration indicated in the system information on an RO associated with the random access configuration.

As discussed, in some cases, the system information may indicate a plurality of random access configurations (e.g., all random access configurations supported by network entity 602). Further, as discussed, for each of one or more random access configurations of the plurality of random access configurations, the system information may indicate a set of applicable features associated with the random access configuration.

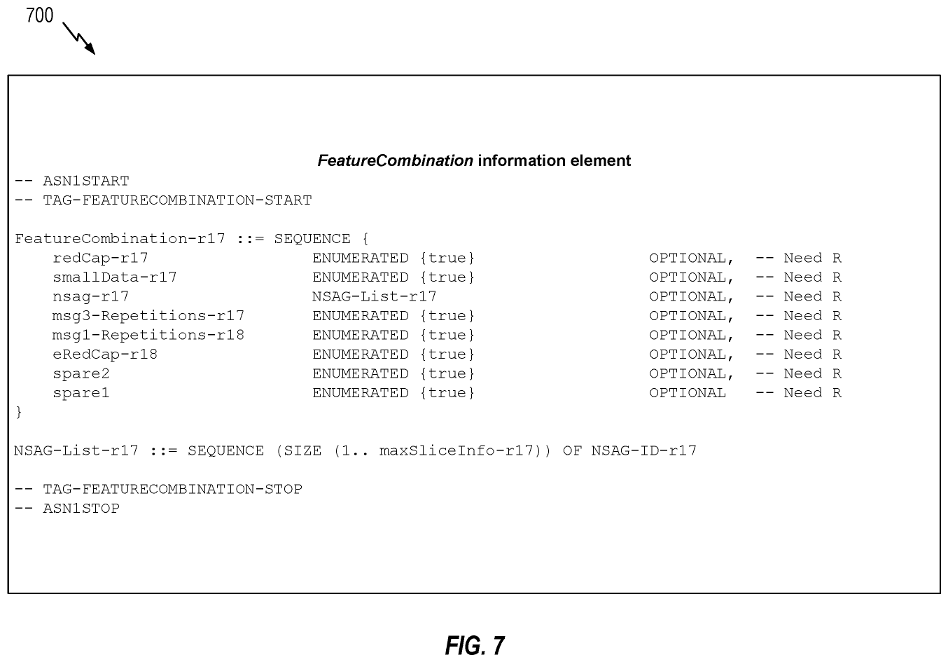

For example, FIG. 7 illustrates example applicable features that may be indicated, such as in an information element, in the system information and/or RRC message. As shown, example applicable features may include: reduced capability (e.g., redCap-r17); small data (e.g., smallData-r17); enhanced reduced capability (e.g., eRedCap-r18); network slice access stratum (AS) group (e.g., nsag-r17); message 3 repetition (e.g., msg3-Repetitions-r17); message 1 repetition (e.g., msg1-Repetitions-r18), and/or the like. For example, additional applicable features may be associated with spare information elements (e.g., spare1 or spare2). A FeatureCombination or feature combination 700 may refer to a set of applicable features, of which an example is shown in FIG. 7.

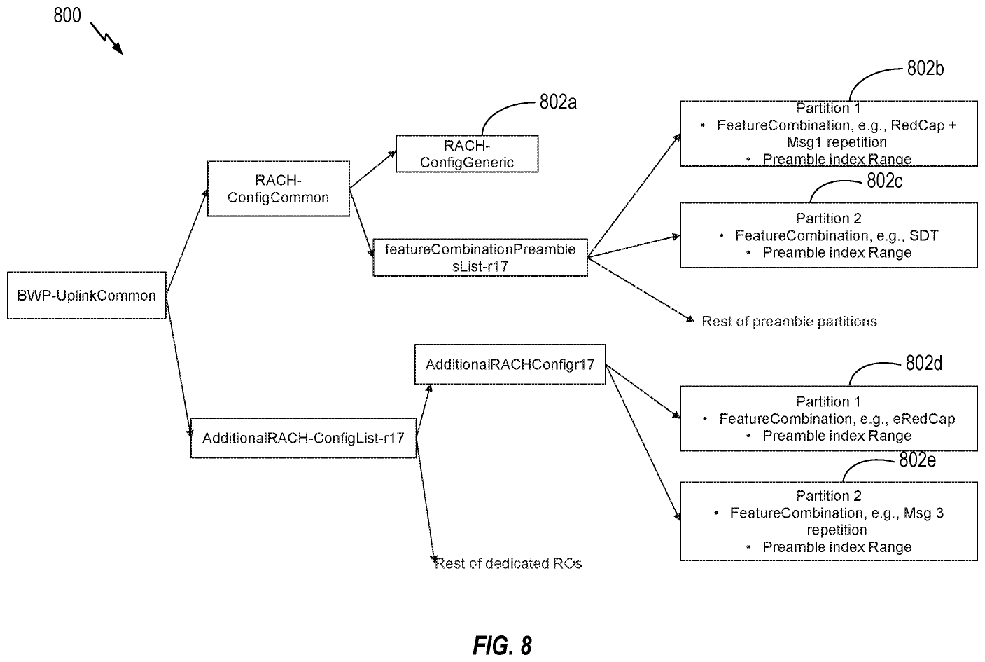

FIG. 8 illustrates an example 800 of a plurality of random access configurations and sets of applicable features associated with random access configurations that may be included in system information.

Example 800 illustrates five explicit random access configurations 802a-802e. There may be fewer or additional random access configurations in system information. Example 800 shows the random access configurations 802a-802e as associated with particular fields in the system information (e.g., BWP-UplinkCommon, RACH-ConfigCommon, etc.) as a non-limiting example.

As shown, random access configuration 802a is a default or common random access configuration (e.g., RACH-ConfigGeneric), and may indicate one or more respective random access preambles and one or more respective ROs associated with random access configuration 802a. A UE may utilize random access configuration 802a for performing random access, such as when the UE does not have another random access configuration associated with applicable features of the UE. For example, any UE may be able to utilize random access configuration 802a for performing random access.

Further, as shown, random access configuration 802b is associated with the set of applicable features including reduced capability and message 1 repetition, and may indicate one or more respective random access preambles and one or more respective ROs associated with random access configuration 802b. A UE may utilize random access configuration 802b for performing random access, such as when the UE is associated with (e.g., supports) only the set of applicable features, when the UE is associated with (e.g., supports) at least the set of applicable features, when the UE is associated with (e.g., supports) at least one applicable feature of the set of applicable features, or according to some other rule.

In addition, as shown, random access configuration 802c is associated with the set of applicable features including small data, and may indicate one or more respective random access preambles and one or more respective ROs associated with random access configuration 802c. A UE may utilize random access configuration 802c for performing random access, such as when the UE is associated with (e.g., supports) only the set of applicable features, when the UE is associated with (e.g., supports) at least the set of applicable features, when the UE is associated with (e.g., supports) at least one applicable feature of the set of applicable features, or according to some other rule.

Also, as shown, random access configuration 802d is associated with the set of applicable features including enhanced reduced capability, and may indicate one or more respective random access preambles and one or more respective ROs associated with random access configuration 802d. A UE may utilize random access configuration 802d for performing random access, such as when the UE is associated with (e.g., supports) only the set of applicable features, when the UE is associated with (e.g., supports) at least the set of applicable features, when the UE is associated with (e.g., supports) at least one applicable feature of the set of applicable features, or according to some other rule.

In addition, as shown, random access configuration 802e is associated with the set of applicable features including message 3 repetition, and may indicate one or more respective random access preambles and one or more respective ROs associated with random access configuration 802e. A UE may utilize random access configuration 802e for performing random access, such as when the UE is associated with (e.g., supports) only the set of applicable features, when the UE is associated with (e.g., supports) at least the set of applicable features, when the UE is associated with (e.g., supports) at least one applicable feature of the set of applicable features, or according to some other rule.

### Aspects Related to On-Demand System Information Based on Applicable Features

As discussed, one technical problem with associating different random access configurations with different sets of applicable features in system information is that, to carry the information associating different random access configurations with different sets of applicable features, the system information may become large and require significant resources and overhead to communicate, including time-frequency resources and processing resources at the network entity and UE.

As discussed, certain aspects herein overcome the technical problem of resources and overhead to communicate system information by reducing the amount of information carried in the system information. For example, in certain aspects, the WUS sent by a UE to a network entity requesting system information may indicate both a request for system information and indicate one or more applicable features of the UE.

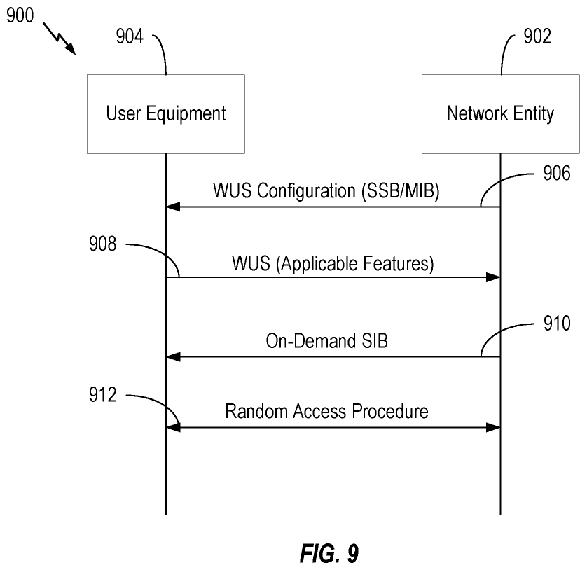

FIG. 9 depicts a process flow diagram of an example on-demand system information procedure 900 performed between a UE 904 and a network entity 902. In some aspects, the UE 904 is the UE 104 depicted and described with respect to FIGS. 1 and 3, and the network entity 902 is the base station 102 depicted and described with respect to FIGS. 1 and 3 or a disaggregated base station depicted and described with respect to FIG. 2.

At 906, network entity 902 sends to UE 904 an indication of a WUS configuration. For example, 906 may be similar to 606 of FIG. 6.

At 908, UE 904 sends to network entity 902 a WUS, such as on a RACH, requesting system information (e.g., SIB1) (e.g., system information including one or more random access configurations for UE 904 to perform a random access procedure). In certain aspects, the WUS includes an indication of one or more applicable features of the UE 904 (e.g., one or more applicable features associated with random access configuration). Further, in certain aspects, the WUS includes an indication of a request for system information. The indication of one or more applicable features and/or indication of the request for system information may be explicit or implicit indications. For example, in certain aspects, the WUS includes (e.g., only) a WUS preamble and the preamble itself indicates (e.g., maps to) a request for system information and/or the one or more applicable features of the UE 904. In certain aspects, the WUS includes a WUS preamble, and additional information (e.g., bits) that indicate a request for system information and/or the one or more applicable features of the UE 904.

At 910, after 908, such as in response to the WUS received at 908, network entity 902 sends, to UE 904, system information (e.g., SIB1). The system information may be referred to as on-demand system information as in it may be sent based on the WUS requesting the system information at 908. The system information may be sent only to UE 904. The system information may be broadcast or sent to multiple UEs, including UE 904, such as where multiple UEs request the system information, such as within a time window.

In certain aspects, the system information, instead of including an indication of all random access configurations of the network entity 902, may include only one or more random access configurations associated with the one or more applicable features of the UE 904 as indicated in the WUS at 908 and/or a default or common random access configuration that may be agnostic of applicable features, meaning it may be for any UE. Accordingly, UE 904 receiving the system information, may determine that the UE 904 can use for random access a random access configuration associated with one or more applicable features of the UE 904. Thus, the size of the system information may be reduced, thereby reducing resources and overhead to communicate system information.

At 912, UE 904 and network entity 902 may perform a random access procedure, such as a four-step RACH procedure or a two-step RACH procedure. For example, UE 904 may send a RACH preamble selected from a random access configuration indicated in the system information on an RO associated with the random access configuration.

In certain aspects, if network entity 902 is unable to decode the WUS communicated at 908 (e.g., but receives the WUS), the network entity 902 may send system information with all random access configurations (e.g., for all sets of applicable features) of network entity 902 (also referred to as all RACH partitions).

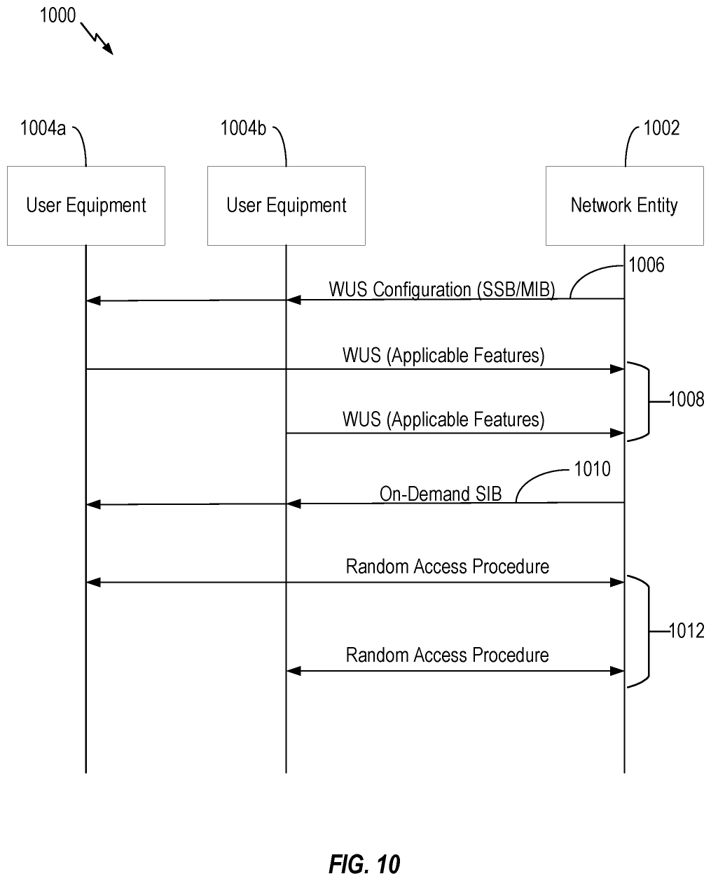

FIG. 10 depicts a process flow diagram of an example on-demand system information procedure 1000 performed between multiple UEs, including a UE 1004a and a UE 1004b, and a network entity 1002. In some aspects, the UEs 1004a and 1004b are similar to the UE 104 depicted and described with respect to FIGS. 1 and 3, and the network entity 1002 is the base station 102 depicted and described with respect to FIGS. 1 and 3 or a disaggregated base station depicted and described with respect to FIG. 2.

Though only two UEs 1004a and 1004b are shown, there may be additional UEs 1004 that perform the procedure 1000, as further discussed.

At 1006, network entity 1002 sends (e.g., broadcasts) to UEs 1004 an indication of a WUS configuration. For example, 1006 may be similar to 906 of FIG. 9.

At 1008, each of the UEs 1004 sends to network entity 1002 (e.g., within a time window or threshold time of one another) a respective WUS, such as on a RACH, requesting system information (e.g., SIB1) (e.g., system information including one or more random access configurations for UE 904 to perform a random access procedure). For example, 1008 may be similar to 908 of FIG. 9. In certain aspects, each respective WUS includes an indication of one or more applicable features of the respective UE 1004 (e.g., one or more applicable features associated with random access configuration). Further, in certain aspects, each respective WUS includes an indication of a request for system information. The indication of one or more applicable features and/or indication of the request for system information may be explicit or implicit indications. For example, in certain aspects, each respective WUS includes (e.g., only) a respective WUS preamble and the preamble itself indicates (e.g., maps to) a request for system information and/or the one or more applicable features of the respective UE 1004. In certain aspects, each respective WUS includes a respective WUS preamble, and additional information (e.g., bits) that indicates a request for system information and/or the one or more applicable features of the respective UE 1004.

At 1010, after 1008, such as in response to the WUSs received at 1008, network entity 1002 sends (e.g., broadcasts), to UEs 1004, system information (e.g., SIB1). The system information may be referred to as on-demand system information as in it may be sent based on the WUSs requesting the system information at 1008. In certain aspects, the system information, instead of including an indication of all random access configurations of the network entity 1002, may include one or more random access configurations, where each of the one or more random access configurations is associated with one or more applicable features of at least one of the UEs 1004 and/or a default or common random access configuration. Accordingly, the network entity 1002 may still send a reduced size system information, but include random access configuration(s) for each of the multiple UEs 1004, further providing communication resource efficiency, such as over sending separate system information to each of the multiple UEs 1004. For example, the system information may include a first random access configuration associated with one or more applicable features of UE 1004a, and a second random access configuration associated with one or more applicable features of UE 1004b. In certain aspects, the first random access configuration and/or second random access configuration may additionally be associated with one or more additional UEs 1004, such as where different UEs 1004 have the same or overlapping applicable features.

At 1012, each of one or more of the UEs 1004 and network entity 1002 may perform a random access procedure, such as a four-step RACH procedure or a two-step RACH procedure. For example, UE 1004a may send a RACH preamble, selected from a random access configuration, indicated as associated with one or more applicable features associated with UE 1004a in the system information, on an RO associated with the random access configuration.

In certain aspects, if network entity 1002 is unable to decode the WUS(s) communicated at 1008 (e.g., but receives the WUS(s)), the network entity 1002 may send system information with all random access configurations (e.g., for all sets of applicable features) of network entity 1002. For example, in certain aspects, if network entity 1002 is unable to decode any one of the WUSs communicated at 1008, the network entity 1002 may send system information with all random access configurations of network entity 1002.

### Aspects Related to On-Demand System Information Based on Timing of Wake Up Signal Communication

As discussed, as another example, the WUS sent by a UE (e.g., at 608 of FIG. 6, at 908 of FIG. 9, or at 1008 of FIG. 10) to a network entity requesting system information, may be based on a WUS preamble (e.g., associated with a WUS preamble identifier (ID)), which may mean that the WUS includes (e.g., only) the WUS preamble itself, or includes the WUS preamble along with one or more additional bits. In certain aspects, the WUS indicates a request for system information, and may be sent in a particular time period (e.g., a system frame number (SFN)).

In certain aspects, in response to the WUS, the network entity is configured to send to the UE, system information (e.g., at 610 of FIG. 6, at 910 of FIG. 9, or at 1010 of FIG. 10). In certain aspects, the system information, for one or more random access configurations indicated in the system information, further includes an indication of an association between each of the one or more random access configurations and a combination of a WUS preamble (e.g., WUS preamble ID) and a time period (e.g., SFN) of communication of a WUS. Accordingly, a UE receiving the system information, may determine that the UE can use for random access a random access configuration associated with the WUS preamble sent by the UE and the time period at which the UE sent the WUS (e.g., and associated with one or more applicable features of the UE).

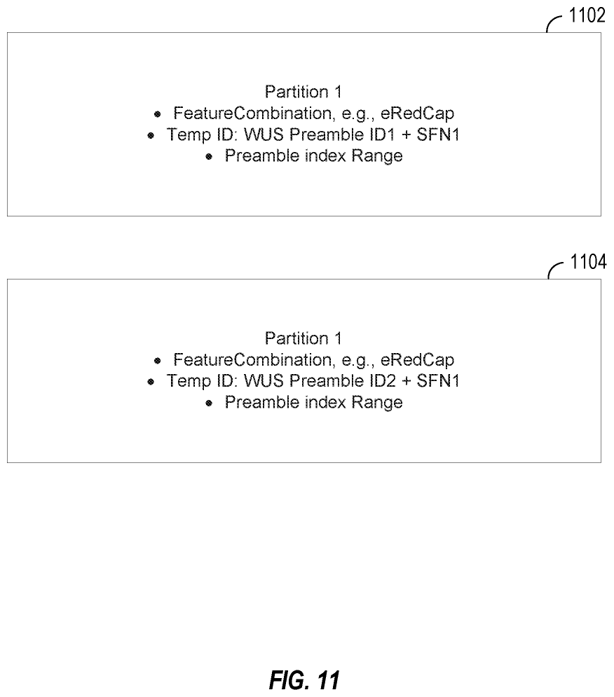

For example, FIG. 11 illustrates two example random access configurations 1102 and 1104 that may be included in the system information. As shown, random access configuration 1102 is associated with the set of applicable features including enhanced reduced capability, and may indicate one or more respective random access preambles and one or more respective ROs associated with random access configuration 1102. Random access configuration 1102 is further associated with WUS preamble ID1 and SFN1. A UE may utilize random access configuration 1102 for performing random access, such as when the UE is associated with (e.g., supports) only the set of applicable features, when the UE is associated with (e.g., supports) at least the set of applicable features, when the UE is associated with (e.g., supports) at least one applicable feature of the set of applicable features, or according to some other rule; and when the UE sent WUS using the WUS preamble associated with WUS preamble ID1 during SFN1.

As shown, random access configuration 1104 is associated with the set of applicable features including enhanced reduced capability, and may indicate one or more respective random access preambles and one or more respective ROs associated with random access configuration 1104. Random access configuration 1104 is further associated with WUS preamble ID2 and SFN1. A UE may utilize random access configuration 1104 for performing random access, such as when the UE is associated with (e.g., supports) only the set of applicable features, when the UE is associated with (e.g., supports) at least the set of applicable features, when the UE is associated with (e.g., supports) at least one applicable feature of the set of applicable features, or according to some other rule; and when the UE sent WUS using the WUS preamble associated with WUS preamble ID2 during SFN1. There may be other random access configurations associated with different combinations of WUS preamble ID and time period (e.g., SFN).

In certain aspects, the system information includes a default or common random access configuration (e.g., RACH-ConfigGeneric), and may indicate one or more respective random access preambles and one or more respective ROs associated with the default or common random access configuration. A UE may utilize the default or common random access configuration for performing random access, such as when the UE does not have another random access configuration associated with the combination of the WUS preamble of the WUS sent by the UE and the time period at which the UE sent the WUS (e.g., and that is not associated with applicable feature(s) associated with the UE).

In certain aspects, the system information, instead of including an indication of all random access configurations of the network entity, may include only one or more random access configurations associated with the WUS preamble and the time period the WUS was sent and/or a default or common random access configuration. Accordingly, the size of the system information may be reduced, thereby reducing resources and overhead to communicate system information.

In certain aspects, a network entity may receive WUS (e.g., at 608 of FIG. 6 or at 1008 of FIG. 10) from multiple UEs (e.g., within a longer time period, also referred to as a time window), each WUS being based on a respective WUS preamble and sent at a respective time, where different UEs may end up using the same or different WUS preambles and may send the WUS at the same or different times. In certain aspects, in response to the WUS from multiple UEs, the network entity is configured to send to the multiple UEs, system information (e.g., one system information to the multiple UEs). In certain aspects, the system information, instead of including an indication of all random access configurations of the network entity, may include one or more random access configurations, where each of the one or more random access configurations is associated with a combination of a WUS preamble used by at least one of the UEs and the time period at which the at least one of the UEs sent the WUS, and/or a default or common random access configuration. Accordingly, the network entity may still send a reduced size system information, but include random access configuration(s) for each of the multiple UEs, further providing communication resource efficiency, such as over sending separate system information to each of the multiple UEs.

### Aspects Related to On-Demand System Information Scheduled by Downlink Control Information

In certain aspects, a network entity may be configured to send downlink control information (DCI) to a UE, the DCI including an indication of one or more time-frequency resources for communication of the system information (e.g., on-demand system information) to the UE. For example, the network entity may send the DCI, for a specific system information, to one or more specific UEs, such that only the one or more specific UEs attempt to receive and decode the specific system information. One advantage may be that different UEs can be scheduled to receive different system information by different DCIs. Another advantage may be that a given UE may not attempt to receive and decode system information, when a DCI is not received by the UE, thereby reducing power consumption at the UE.

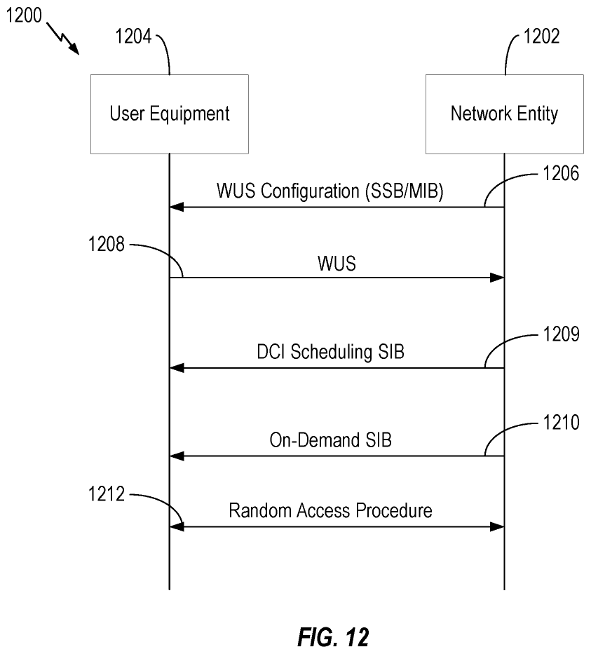

FIG. 12 depicts a process flow diagram of an example on-demand system information procedure 1200 performed between a UE 1204 and a network entity 1202. In some aspects, the UE 1204 is the UE 104 depicted and described with respect to FIGS. 1 and 3, and the network entity 1202 is the base station 102 depicted and described with respect to FIGS. 1 and 3 or a disaggregated base station depicted and described with respect to FIG. 2.

At 1206, network entity 1202 sends to UE 1204 an indication of a WUS configuration. For example, 1206 may be the same or similar as 606 of FIG. 6, 906 of FIG. 9, or 1006 of FIG. 10.

At 1208, UE 1204 sends to network entity 1202 a WUS. For example, 1208 may be the same or similar as 608 of FIG. 6, 908 of FIG. 9, or 1008 of FIG. 10.

At 1209, UE 1204 sends to network entity 1202 a DCI scheduling system information (e.g., SIB1). For example, the DCI may include an indication of one or more time-frequency resources for communication of system information, as further discussed herein.

At 1210, network entity 1202 sends to UE 1204 system information. For example, 1210 may be the same or similar as 610 of FIG. 6, 910 of FIG. 9, or 1010 of FIG. 10. UE 1204 may determine to receive and decode the system information based on the DCI received at 1209. Further, UE 1204 may determine on which time-frequency resources to receive the system information based on the DCI received at 1209.

At 1212, UE 1204 and network entity 1202 may perform a random access procedure, such as a four-step RACH procedure or a two-step RACH procedure. For example, UE 1204 may send a RACH preamble selected from a random access configuration indicated in the system information on an RO associated with the random access configuration.

In certain aspects, the DCI communicated at 1209 may include an indication of the WUS preamble on which the WUS communicated at 1208 is based. In certain aspects, the indication of the WUS preamble is the WUS preamble itself. In certain aspects, the indication of the WUS preamble is based on the WUS preamble, such as where the indication is a random access preamble identifier (RAPID) that may be based on the WUS preamble (e.g., a function of the WUS preamble). Accordingly, the UE 1204 may determine the DCI is intended for the UE 1204 based on the DCI including an indication of the WUS preamble on which the WUS communicated by the UE 1204 at 1208 is based. For example, multiple UEs may be monitoring the same CORESET and search space, and may not be able to determine whether the DCI is intended for the UE without some indicator in the DCI.

In certain aspects, the DCI communicated at 1209 may include feedback (e.g., message 2 or MSG2) regarding the WUS communicated at 1208, such as an acknowledgement (ACK) that the network entity 1202 successfully received and decoded the WUS. Further, in some aspects, the network entity 1202 is configured to scramble the system information (and/or PDSCH DMRS) sent at 1210 using an indication of the WUS preamble (e.g., WUS preamble, RAPID, etc.). Accordingly, the UE 1204 may determine the system information is intended for the UE 1204 based on being able to descramble the system information using an indication of the WUS preamble on which the WUS communicated by the UE 1204 at 1208 is based.

In certain aspects, UE capability/applicable feature set signaling may be performed when the UE 1204 completes the random access procedure 1212, and system information may be customized accordingly (e.g., applicable feature indications may not be indicated in WUS).

In certain aspects, the WUS at 1208 comprises message one of a four-step random access procedure, the DCI at 1209 comprises message two of the four-step random access procedure, and the system information at 1210 comprises message three of the four-step random access procedure.

In certain aspects, the WUS at 1208 (or 908 of FIG. 9, or 1008 of FIG. 10) comprises message A of a two-step random access procedure and the system information at 1210 (or 910 of FIG. 9, or 1010 of FIG. 10) comprises message B of the two-step random access procedure. For example, the message A may include an indication of one or more applicable features of a UE (e.g., UE 1204), and the indication of one or more applicable features of the UE may include one or more preambles associated with the one or more applicable features. For example, the UE may select a preamble for WUS (e.g., from a random set) and another sequence of preambles that are associated with (e.g., mapped to) one or more applicable features.

### Example Operations

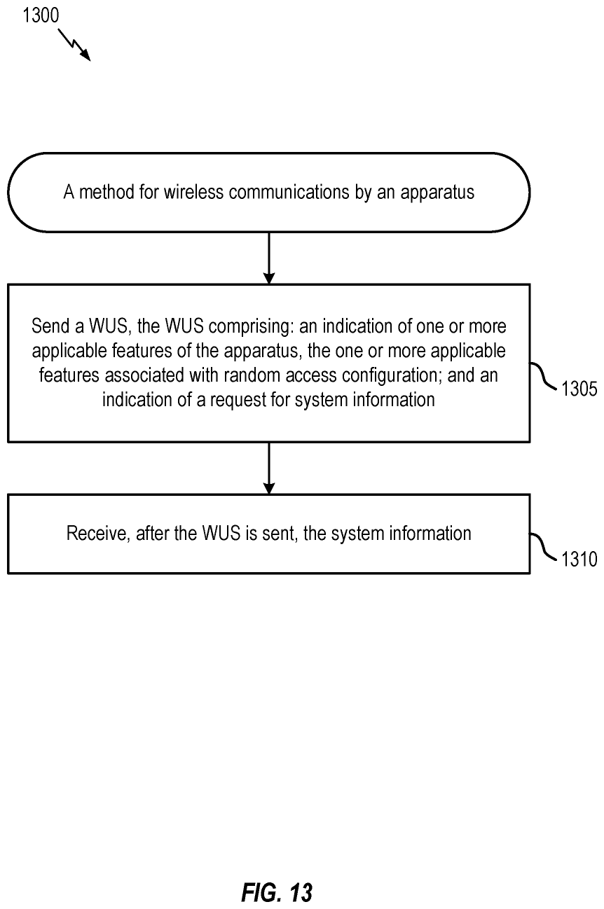

FIG. 13 shows a method 1300 for wireless communications by an apparatus, such as UE 104 of FIGS. 1 and 3.

Method 1300 begins at block 1305 with sending a WUS, the WUS comprising: an indication of one or more applicable features of the apparatus, the one or more applicable features associated with random access configuration; and an indication of a request for system information.

Method 1300 then proceeds to block 1310 with receiving, after the WUS is sent, the system information.

In certain aspects, the system information comprises: an indication of one or more random access configurations, each of the one or more random access configurations comprising respective one or more random access preambles and respective one or more random access occasions.

In certain aspects, method 1300 further includes sending a first random access preamble on a first random access occasion, wherein: the respective one or more random access preambles, of a first random access configuration of the one or more random access configurations, comprises the first random access preamble; and the respective one or more random access occasions, of the first random access configuration, comprises the first random access occasion.

In certain aspects, the one or more random access configurations are associated with the one or more applicable features.

In certain aspects, at least a first random access configuration, of the one or more random access configurations, is associated with the one or more applicable features; and at least a second random access configuration, of the one or more random access configurations, is not associated with the one or more applicable features.

In certain aspects, block 1305 includes sending the WUS in a time period; the WUS is based on a WUS preamble; and the system information comprises an indication of an association between a first random access configuration, of the one or more random access configurations, and a combination of a first WUS preamble and a first time period.

In certain aspects, the first WUS preamble comprises the WUS preamble; and the first time period comprises the time period.

In certain aspects, none of the one or more random access configurations is associated with the combination of the WUS preamble and the time period; and the one or more random access configurations comprise a common random access configuration.

In certain aspects, method 1300 further includes receiving DCI comprising an indication of one or more time-frequency resources for communication of the system information.

In certain aspects, the WUS is based on a WUS preamble; and the DCI comprises an indication of the WUS preamble.

In certain aspects, the WUS is based on a WUS preamble; the DCI comprises an acknowledgement of the WUS; and the system information is scrambled with an indication of the WUS preamble.

In certain aspects, the WUS comprises message one of a four-step random access procedure; the DCI comprises message two of the four-step random access procedure; and the system information comprises message three of the four-step random access procedure.

In certain aspects, the WUS comprises message A of a two-step random access procedure; and the system information comprises message B of the two-step random access procedure.

In certain aspects, the WUS is based on a WUS preamble; the message A comprises the indication of the one or more applicable features of the apparatus; and the indication of the one or more applicable features of the apparatus comprises one or more preambles associated with the one or more applicable features.

In certain aspects, method 1300 further includes receiving an indication of a WUS configuration, the WUS configuration comprising: an indication of one or more WUS preambles available for communication of the WUS; and an indication of one or more time frequency resources available for communication of the WUS.

In certain aspects, the one or more applicable features of the apparatus comprise one or more of: reduced capability; small data; enhanced reduced capability; network slice AS group; message 3 repetition; or message 1 repetition.

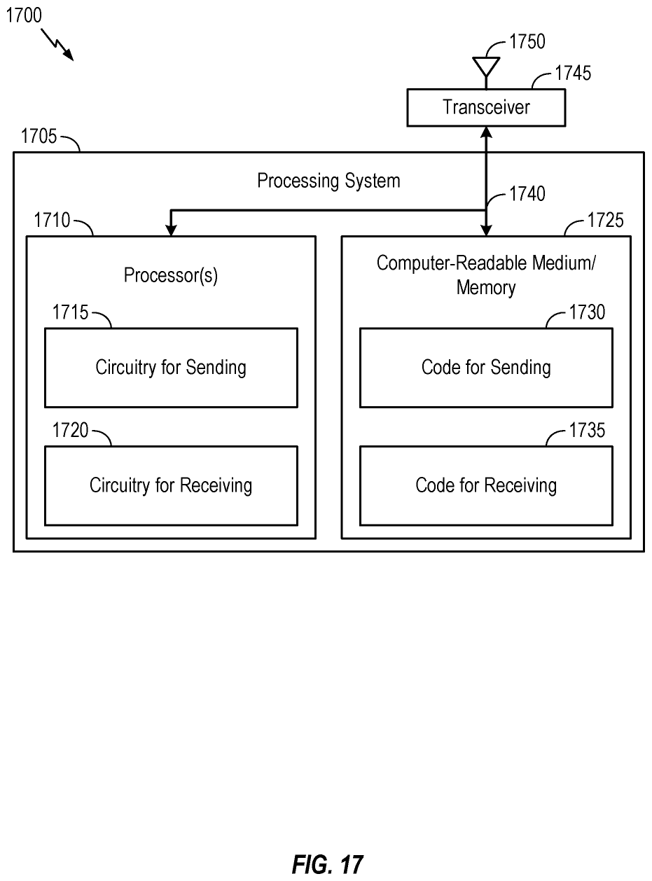

In certain aspects, method 1300, or any aspect related to it, may be performed by an apparatus, such as communications device 1700 of FIG. 17, which includes various components operable, configured, or adapted to perform the method 1300. Communications device 1700 is described below in further detail.

Note that FIG. 13 is just one example of a method, and other methods including fewer, additional, or alternative operations are possible consistent with this disclosure.

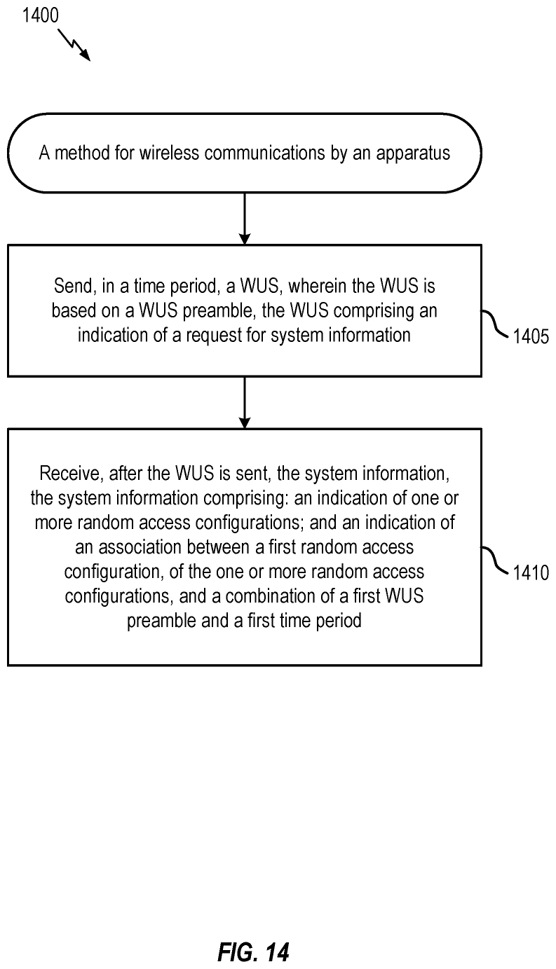

FIG. 14 shows a method 1400 for wireless communications by an apparatus, such as UE 104 of FIGS. 1 and 3.

Method 1400 begins at block 1405 with sending, in a time period, a WUS, wherein the WUS is based on a WUS preamble, the WUS comprising an indication of a request for system information.

Method 1400 then proceeds to block 1410 with receiving, after the WUS is sent, the system information, the system information comprising: an indication of one or more random access configurations; and an indication of an association between a first random access configuration, of the one or more random access configurations, and a combination of a first WUS preamble and a first time period.

In certain aspects, the first WUS preamble comprises the WUS preamble; and the first time period comprises the time period.

In certain aspects, none of the one or more random access configurations is associated with the combination of the WUS preamble and the time period; and the one or more random access configurations comprise a common random access configuration.

In certain aspects, each of the one or more random access configurations comprises respective one or more random access preambles and respective one or more random access occasions.

In certain aspects, method 1400 further includes sending a first random access preamble on a first random access occasion, wherein: the respective one or more random access preambles, of a random access configuration of the one or more random access preambles, comprise the first random access preamble; and the respective one or more random access occasions, of the random access configuration, comprise the first random access occasion.

In certain aspects, method 1400 further includes receiving DCI comprising an indication of one or more time-frequency resources for communication of the system information.

In certain aspects, the DCI comprises an indication of the WUS preamble.

In certain aspects, the DCI comprises an acknowledgement of the WUS; and the system information is scrambled with second indication of the WUS preamble.

In certain aspects, the WUS comprises message one of a four-step random access procedure; the DCI comprises message two of the four-step random access procedure; and the system information comprises message three of the four-step random access procedure.

In certain aspects, method 1400 further includes receiving an indication of a WUS configuration, the WUS configuration comprising: an indication of one or more WUS preambles available for communication of the WUS; and an indication of one or more time frequency resources available for communication of the WUS.

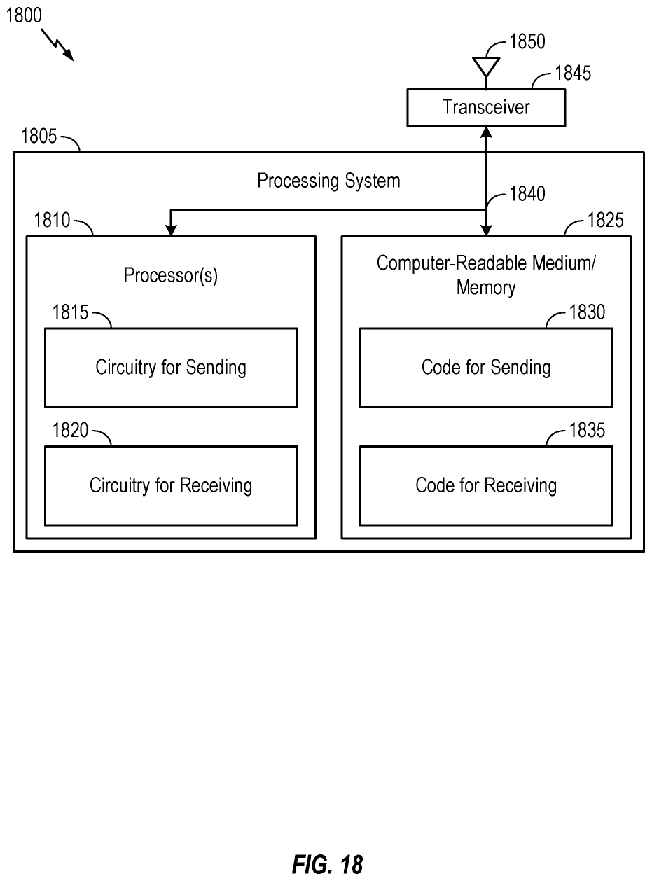

In certain aspects, method 1400, or any aspect related to it, may be performed by an apparatus, such as communications device 1800 of FIG. 18, which includes various components operable, configured, or adapted to perform the method 1400. Communications device 1800 is described below in further detail.

Note that FIG. 14 is just one example of a method, and other methods including fewer, additional, or alternative operations are possible consistent with this disclosure.

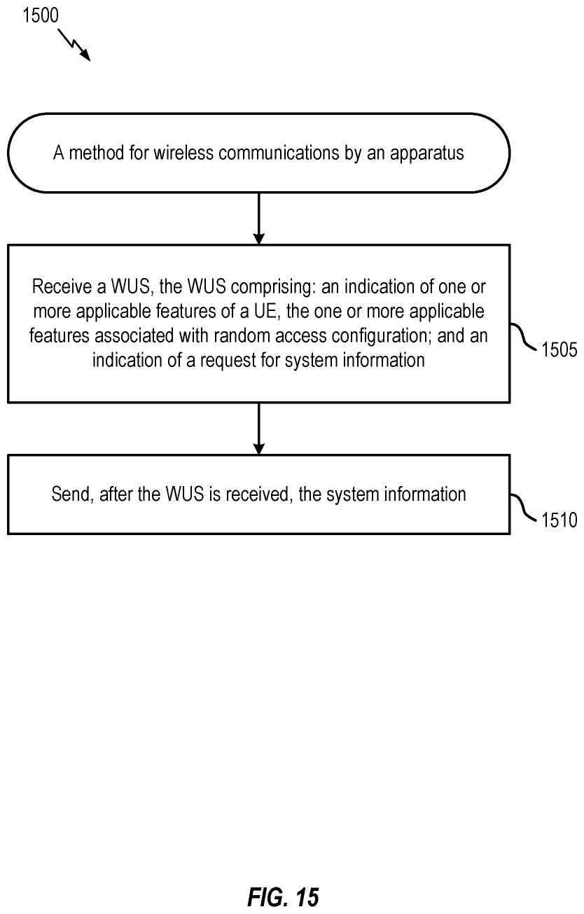

FIG. 15 shows a method 1500 for wireless communications by an apparatus, such as BS 102 of FIGS. 1 and 3, or a disaggregated base station as discussed with respect to FIG. 2.

Method 1500 begins at block 1505 with receiving a WUS, the WUS comprising: an indication of one or more applicable features of a UE, the one or more applicable features associated with random access configuration; and an indication of a request for system information.

Method 1500 then proceeds to block 1510 with sending, after the WUS is received, the system information.

In certain aspects, the system information comprises: an indication of one or more random access configurations, each of the one or more random access configurations comprising respective one or more random access preambles and respective one or more random access occasions.

In certain aspects, method 1500 further includes receiving a first random access preamble on a first random access occasion, wherein: the respective one or more random access preambles, of a first random access configuration of the one or more random access configurations, comprises the first random access preamble; and the respective one or more random access occasions, of the first random access configuration, comprises the first random access occasion.

In certain aspects, the one or more random access configurations are associated with the one or more applicable features.

In certain aspects, at least a first random access configuration, of the one or more random access configurations, is associated with the one or more applicable features; and at least a second random access configuration, of the one or more random access configurations, is not associated with the one or more applicable features.

In certain aspects, block 1505 includes receiving the WUS in a time period; the WUS is based on a WUS preamble; and the system information comprises an indication of an association between a first random access configuration, of the one or more random access configurations, and a combination of a first WUS preamble and a first time period.

In certain aspects, the first WUS preamble comprises the WUS preamble; and the first time period comprises the time period.

In certain aspects, none of the one or more random access configurations is associated with the combination of the WUS preamble and the time period; and the one or more random access configurations comprise a common random access configuration.

In certain aspects, method 1500 further includes sending DCI comprising an indication of one or more time-frequency resources for communication of the system information.

In certain aspects, the WUS is based on a WUS preamble; and the DCI comprises an indication of the WUS preamble.

In certain aspects, the WUS is based on a WUS preamble; the DCI comprises an acknowledgement of the WUS; and the system information is scrambled with an indication of the WUS preamble.

In certain aspects, the WUS comprises message one of a four-step random access procedure; the DCI comprises message two of the four-step random access procedure; and the system information comprises message three of the four-step random access procedure.

In certain aspects, the WUS comprises message A of a two-step random access procedure; and the system information comprises message B of the two-step random access procedure.

In certain aspects, the WUS is based on a WUS preamble; the message A comprises the indication of the one or more applicable features of the apparatus; and the indication of the one or more applicable features of the apparatus comprises one or more preambles associated with the one or more applicable features.

In certain aspects, method 1500 further includes sending an indication of a WUS configuration, the WUS configuration comprising: an indication of one or more WUS preambles available for communication of the WUS; and an indication of one or more time frequency resources available for communication of the WUS.

In certain aspects, the one or more applicable features of the UE comprise one or more of: reduced capability; small data; enhanced reduced capability; network slice AS group; message 3 repetition; or message 1 repetition.

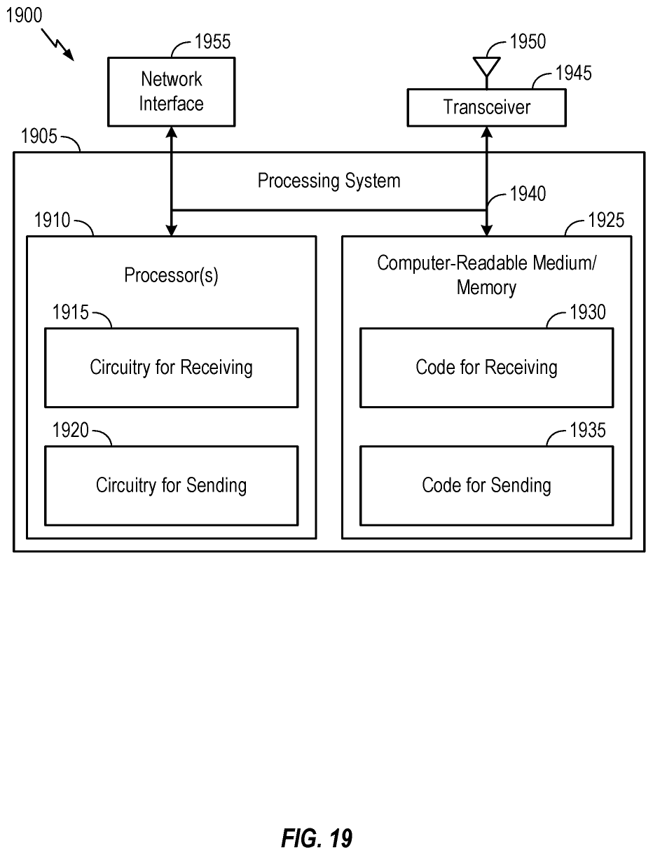

In certain aspects, method 1500, or any aspect related to it, may be performed by an apparatus, such as communications device 1900 of FIG. 19, which includes various components operable, configured, or adapted to perform the method 1500. Communications device 1900 is described below in further detail.

Note that FIG. 15 is just one example of a method, and other methods including fewer, additional, or alternative operations are possible consistent with this disclosure.

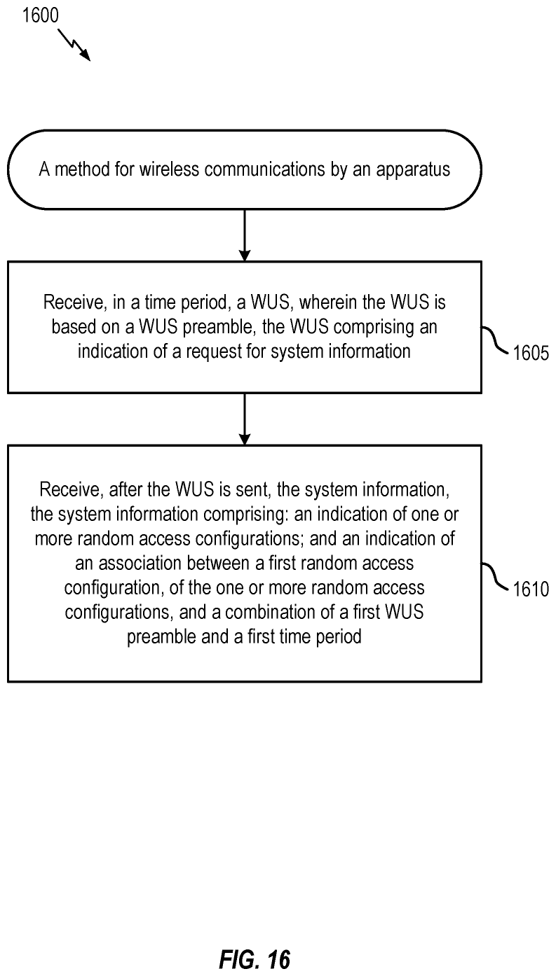

FIG. 16 shows a method 1600 for wireless communications by an apparatus, such as BS 102 of FIGS. 1 and 3, or a disaggregated base station as discussed with respect to FIG. 2.

Method 1600 begins at block 1605 with receiving, in a time period, a WUS, wherein the WUS is based on a WUS preamble, the WUS comprising an indication of a request for system information.

Method 1600 then proceeds to block 1610 with receiving, after the WUS is sent, the system information, the system information comprising: an indication of one or more random access configurations; and an indication of an association between a first random access configuration, of the one or more random access configurations, and a combination of a first WUS preamble and a first time period.

In certain aspects, the first WUS preamble comprises the WUS preamble; and the first time period comprises the time period.

In certain aspects, none of the one or more random access configurations is associated with the combination of the WUS preamble and the time period; and the one or more random access configurations comprise a common random access configuration.

In certain aspects, each of the one or more random access configurations comprises respective one or more random access preambles and respective one or more random access occasions.

In certain aspects, method 1600 further includes receiving a first random access preamble on a first random access occasion, wherein: the respective one or more random access preambles, of a random access configuration of the one or more random access preambles, comprise the first random access preamble; and the respective one or more random access occasions, of the random access configuration, comprise the first random access occasion.

In certain aspects, method 1600 further includes sending DCI comprising an indication of one or more time-frequency resources for communication of the system information.

In certain aspects, the DCI comprises an indication of the WUS preamble.

In certain aspects, the DCI comprises an acknowledgement of the WUS; and the system information is scrambled with second indication of the WUS preamble.

In certain aspects, the WUS comprises message one of a four-step random access procedure; the DCI comprises message two of the four-step random access procedure; and the system information comprises message three of the four-step random access procedure.

In certain aspects, method 1600 further includes sending an indication of a WUS configuration, the WUS configuration comprising: an indication of one or more WUS preambles available for communication of the WUS; and an indication of one or more time frequency resources available for communication of the WUS.

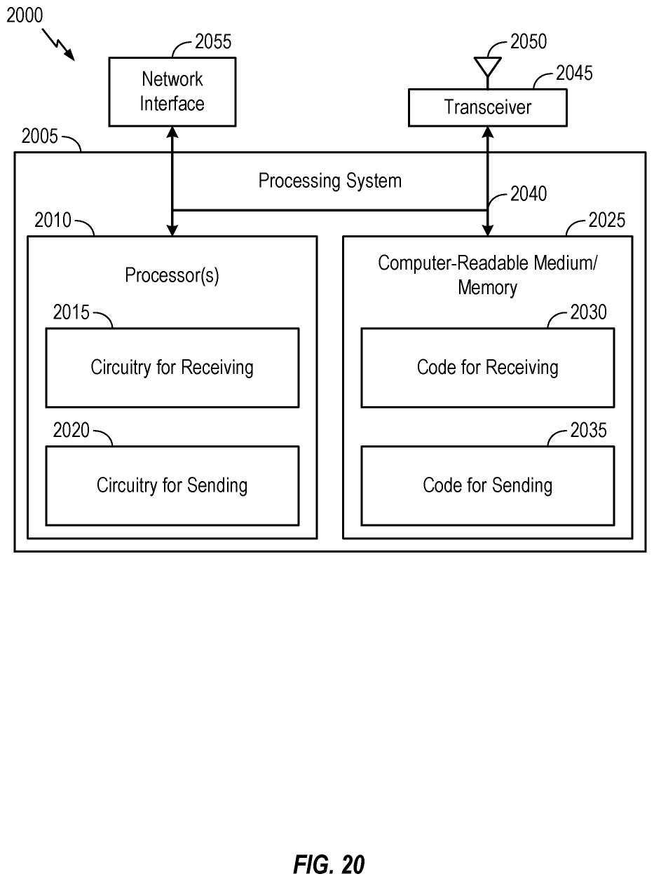

In certain aspects, method 1600, or any aspect related to it, may be performed by an apparatus, such as communications device 2000 of FIG. 20, which includes various components operable, configured, or adapted to perform the method 1600. Communications device 2000 is described below in further detail.

Note that FIG. 16 is just one example of a method, and other methods including fewer, additional, or alternative operations are possible consistent with this disclosure.

### Example Communications Devices

FIG. 17 depicts aspects of an example communications device 1700. In some aspects, communications device 1700 is a user equipment, such as UE 104 described above with respect to FIGS. 1 and 3.

The communications device 1700 includes a processing system 1705 coupled to a transceiver 1745 (e.g., a transmitter and/or a receiver). The transceiver 1745 is configured to transmit and receive signals for the communications device 1700 via an antenna 1750, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. The one or more processors 1710 are coupled to a computer-readable medium/memory 1725 via a bus 1740. In certain aspects, the computer-readable medium/memory 1725 is configured to store instructions (e.g., computer-executable code) that when executed by the one or more processors 1710, enable and cause the one or more processors 1710 to perform the method 1300 described with respect to FIG. 13, or any aspect related to it, including any operations described in relation to FIG. 13. Note that reference to a processor performing a function of communications device 1700 may include one or more processors performing that function of communications device 1700, such as in a distributed fashion.

In the depicted example, computer-readable medium/memory 1725 stores code for sending 1730 and code for receiving 1735. Processing of the code 1730 and 1735 may enable and cause the communications device 1700 to perform the method 1300 described with respect to FIG. 13, or any aspect related to it.

The one or more processors 1710 include circuitry configured to implement (e.g., execute) the code stored in the computer-readable medium/memory 1725, including circuitry for sending 1715 and circuitry for receiving 1720. Processing with circuitry 1715 and 1720 may enable and cause the communications device 1700 to perform the method 1300 described with respect to FIG. 13, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1745 and/or antenna 1750 of the communications device 1700 in FIG. 17, and/or one or more processors 1710 of the communications device 1700 in FIG. 17. Means for communicating, receiving or obtaining may include the transceivers 354, antenna(s) 352, receive processor 358, AI processor 370, and/or controller/processor 380 of the UE 104 illustrated in FIG. 3, transceiver 1745 and/or antenna 1750 of the communications device 1700 in FIG. 17, and/or one or more processors 1710 of the communications device 1700 in FIG. 17.

FIG. 18 depicts aspects of an example communications device 1800. In some aspects, communications device 1800 is a user equipment, such as UE 104 described above with respect to FIGS. 1 and 3.

The communications device 1800 includes a processing system 1805 coupled to a transceiver 1845 (e.g., a transmitter and/or a receiver). The transceiver 1845 is configured to transmit and receive signals for the communications device 1800 via an antenna 1850, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. The one or more processors 1810 are coupled to a computer-readable medium/memory 1825 via a bus 1840. In certain aspects, the computer-readable medium/memory 1825 is configured to store instructions (e.g., computer-executable code) that when executed by the one or more processors 1810, enable and cause the one or more processors 1810 to perform the method 1400 described with respect to FIG. 14, or any aspect related to it, including any operations described in relation to FIG. 14. Note that reference to a processor performing a function of communications device 1800 may include one or more processors performing that function of communications device 1800, such as in a distributed fashion.

In the depicted example, computer-readable medium/memory 1825 stores code for sending 1830 and code for receiving 1835. Processing of the code 1830 and 1835 may enable and cause the communications device 1800 to perform the method 1400 described with respect to FIG. 14, or any aspect related to it.

The one or more processors 1810 include circuitry configured to implement (e.g., execute) the code stored in the computer-readable medium/memory 1825, including circuitry for sending 1815 and circuitry for receiving 1820. Processing with circuitry 1815 and 1820 may enable and cause the communications device 1800 to perform the method 1400 described with respect to FIG. 14, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1845 and/or antenna 1850 of the communications device 1800 in FIG. 18, and/or one or more processors 1810 of the communications device 1800 in FIG. 18. Means for communicating, receiving or obtaining may include the transceivers 354, antenna(s) 352, receive processor 358, AI processor 370, and/or controller/processor 380 of the UE 104 illustrated in FIG. 3, transceiver 1845 and/or antenna 1850 of the communications device 1800 in FIG. 18, and/or one or more processors 1810 of the communications device 1800 in FIG. 18.

FIG. 19 depicts aspects of an example communications device 1900. In some aspects, communications device 1900 is a network entity, such as BS 102 of FIGS. 1 and 3, or a disaggregated base station as discussed with respect to FIG. 2.

The communications device 1900 includes a processing system 1905 coupled to a transceiver 1945 (e.g., a transmitter and/or a receiver) and/or a network interface 1955. The transceiver 1945 is configured to transmit and receive signals for the communications device 1900 via an antenna 1950, such as the various signals as described herein. The network interface 1955 is configured to obtain and send signals for the communications device 1900 via communications link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910. In various aspects, one or more processors 1910 may be representative of one or more of receive processor 338, transmit processor 320, TX MIMO processor 330, and/or controller/processor 340, as described with respect to FIG. 3. The one or more processors 1910 are coupled to a computer-readable medium/memory 1925 via a bus 1940. In certain aspects, the computer-readable medium/memory 1925 is configured to store instructions (e.g., computer-executable code) that when executed by the one or more processors 1910, enable and cause the one or more processors 1910 to perform the method 1500 described with respect to FIG. 15, or any aspect related to it, including any operations described in relation to FIG. 15. Note that reference to a processor of communications device 1900 performing a function may include one or more processors of communications device 1900 performing that function, such as in a distributed fashion.

In the depicted example, the computer-readable medium/memory 1925 stores code for receiving 1930 and code for sending 1935. Processing of the code 1930 and 1935 may enable and cause the communications device 1900 to perform the method 1500 described with respect to FIG. 15, or any aspect related to it.

The one or more processors 1910 include circuitry configured to implement (e.g., execute) the code stored in the computer-readable medium/memory 1925, including circuitry for receiving 1915 and circuitry for sending 1920. Processing with circuitry 1915 and 1920 may enable and cause the communications device 1900 to perform the method 1500 described with respect to FIG. 15, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1945, antenna 1950, and/or network interface 1955 of the communications device 1900 in FIG. 19, and/or one or more processors 1910 of the communications device 1900 in FIG. 19. Means for communicating, receiving or obtaining may include the transceivers 332, antenna(s) 334, receive processor 338, AI processor 318, and/or controller/processor 340 of the BS 102 illustrated in FIG. 3, transceiver 1945, antenna 1950, and/or network interface 1955 of the communications device 1900 in FIG. 19, and/or one or more processors 1910 of the communications device 1900 in FIG. 19.

FIG. 20 depicts aspects of an example communications device 2000. In some aspects, communications device 2000 is a network entity, such as BS 102 of FIGS. 1 and 3, or a disaggregated base station as discussed with respect to FIG. 2.

The communications device 2000 includes a processing system 2005 coupled to a transceiver 2045 (e.g., a transmitter and/or a receiver) and/or a network interface 2055. The transceiver 2045 is configured to transmit and receive signals for the communications device 2000 via an antenna 2050, such as the various signals as described herein. The network interface 2055 is configured to obtain and send signals for the communications device 2000 via communications link(s), such as a backhaul link, midhaul link, and/or fronthaul link as described herein, such as with respect to FIG. 2. The processing system 2005 may be configured to perform processing functions for the communications device 2000, including processing signals received and/or to be transmitted by the communications device 2000.

The processing system 2005 includes one or more processors 2010. In various aspects, one or more processors 2010 may be representative of one or more of receive processor 338, transmit processor 320, TX MIMO processor 330, and/or controller/processor 340, as described with respect to FIG. 3. The one or more processors 2010 are coupled to a computer-readable medium/memory 2025 via a bus 2040. In certain aspects, the computer-readable medium/memory 2025 is configured to store instructions (e.g., computer-executable code) that when executed by the one or more processors 2010, enable and cause the one or more processors 2010 to perform the method 1600 described with respect to FIG. 16, or any aspect related to it, including any operations described in relation to FIG. 16. Note that reference to a processor of communications device 2000 performing a function may include one or more processors of communications device 2000 performing that function, such as in a distributed fashion.

In the depicted example, the computer-readable medium/memory 2025 stores code for receiving 2030 and code for sending 2035. Processing of the code 2030 and 2035 may enable and cause the communications device 2000 to perform the method 1600 described with respect to FIG. 16, or any aspect related to it.

The one or more processors 2010 include circuitry configured to implement (e.g., execute) the code stored in the computer-readable medium/memory 2025, including circuitry for receiving 2015 and circuitry for sending 2020. Processing with circuitry 2015 and 2020 may enable and cause the communications device 2000 to perform the method 1600 described with respect to FIG. 16, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 2045, antenna 2050, and/or network interface 2055 of the communications device 2000 in FIG. 20, and/or one or more processors 2010 of the communications device 2000 in FIG. 20. Means for communicating, receiving or obtaining may include the transceivers 332, antenna(s) 334, receive processor 338, AI processor 318, and/or controller/processor 340 of the BS 102 illustrated in FIG. 3, transceiver 2045, antenna 2050, and/or network interface 2055 of the communications device 2000 in FIG. 20, and/or one or more processors 2010 of the communications device 2000 in FIG. 20.

### Example Clauses

Implementation examples are described in the following numbered clauses:

Clause 1: A method for wireless communications by an apparatus comprising: sending a WUS, the WUS comprising: an indication of one or more applicable features of the apparatus, the one or more applicable features associated with random access configuration; and an indication of a request for system information; and receiving, after the WUS is sent, the system information.

Clause 2: The method of Clause 1, wherein the system information comprises: an indication of one or more random access configurations, each of the one or more random access configurations comprising respective one or more random access preambles and respective one or more random access occasions.

Clause 3: The method of Clause 2, further comprising: sending a first random access preamble on a first random access occasion, wherein: the respective one or more random access preambles, of a first random access configuration of the one or more random access configurations, comprises the first random access preamble; and the respective one or more random access occasions, of the first random access configuration, comprises the first random access occasion.

Clause 4: The method of Clause 2, wherein the one or more random access configurations are associated with the one or more applicable features.

Clause 5: The method of Clause 2, wherein: at least a first random access configuration, of the one or more random access configurations, is associated with the one or more applicable features; and at least a second random access configuration, of the one or more random access configurations, is not associated with the one or more applicable features.

Clause 6: The method of Clause 2, wherein: sending the WUS comprises sending the WUS in a time period; the WUS is based on a WUS preamble; and the system information comprises an indication of an association between a first random access configuration, of the one or more random access configurations, and a combination of a first WUS preamble and a first time period.

Clause 7: The method of Clause 6, wherein: the first WUS preamble comprises the WUS preamble; and the first time period comprises the time period.

Clause 8: The method of Clause 6, wherein: none of the one or more random access configurations is associated with the combination of the WUS preamble and the time period; and the one or more random access configurations comprise a common random access configuration.

Clause 9: The method of any one of Clauses 1-8, further comprising: receiving DCI comprising an indication of one or more time-frequency resources for communication of the system information.

Clause 10: The method of Clause 9, wherein: the WUS is based on a WUS preamble; and the DCI comprises an indication of the WUS preamble.

Clause 11: The method of Clause 9, wherein: the WUS is based on a WUS preamble; the DCI comprises an acknowledgement of the WUS; and the system information is scrambled with an indication of the WUS preamble.

Clause 12: The method of Clause 9, wherein: the WUS comprises message one of a four-step random access procedure; the DCI comprises message two of the four-step random access procedure; and the system information comprises message three of the four-step random access procedure.

Clause 13: The method of any one of Clauses 1-11, wherein: the WUS comprises message A of a two-step random access procedure; and the system information comprises message B of the two-step random access procedure.

Clause 14: The method of Clause 13, wherein: the WUS is based on a WUS preamble; the message A comprises the indication of the one or more applicable features of the apparatus; and the indication of the one or more applicable features of the apparatus comprises one or more preambles associated with the one or more applicable features.

Clause 15: The method of any one of Clauses 1-14, further comprising: receiving an indication of a WUS configuration, the WUS configuration comprising: an indication of one or more WUS preambles available for communication of the WUS; and an indication of one or more time frequency resources available for communication of the WUS.

Clause 16: The method of any one of Clauses 1-15, wherein the one or more applicable features of the apparatus comprise one or more of: reduced capability; small data; enhanced reduced capability; network slice AS group; message 3 repetition; or message 1 repetition.

Clause 17: A method for wireless communications by an apparatus comprising: sending, in a time period, a WUS, wherein the WUS is based on a WUS preamble, the WUS comprising an indication of a request for system information; and receiving, after the WUS is sent, the system information, the system information comprising: an indication of one or more random access configurations; and an indication of an association between a first random access configuration, of the one or more random access configurations, and a combination of a first WUS preamble and a first time period.

Clause 18: The method of Clause 17, wherein: the first WUS preamble comprises the WUS preamble; and the first time period comprises the time period.

Clause 19: The method of any one of Clauses 17-18, wherein: none of the one or more random access configurations is associated with the combination of the WUS preamble and the time period; and the one or more random access configurations comprise a common random access configuration.

Clause 20: The method of any one of Clauses 17-19, wherein each of the one or more random access configurations comprises respective one or more random access preambles and respective one or more random access occasions.

Clause 21: The method of Clause 20, further comprising: sending a first random access preamble on a first random access occasion, wherein: the respective one or more random access preambles, of a random access configuration of the one or more random access preambles, comprise the first random access preamble; and the respective one or more random access occasions, of the random access configuration, comprise the first random access occasion.

Clause 22: The method of any one of Clauses 17-21, further comprising: receiving DCI comprising an indication of one or more time-frequency resources for communication of the system information.

Clause 23: The method of Clause 22, wherein: the DCI comprises an indication of the WUS preamble.

Clause 24: The method of Clause 22, wherein: the DCI comprises an acknowledgement of the WUS; and the system information is scrambled with second indication of the WUS preamble.

Clause 25: The method of Clause 22, wherein: the WUS comprises message one of a four-step random access procedure; the DCI comprises message two of the four-step random access procedure; and the system information comprises message three of the four-step random access procedure.

Clause 26: The method of any one of Clauses 17-25, further comprising: receiving an indication of a WUS configuration, the WUS configuration comprising: an indication of one or more WUS preambles available for communication of the WUS; and an indication of one or more time frequency resources available for communication of the WUS.

Clause 27: A method for wireless communications by an apparatus comprising: receiving a WUS, the WUS comprising: an indication of one or more applicable features of a UE, the one or more applicable features associated with random access configuration; and an indication of a request for system information; and sending, after the WUS is received, the system information.

Clause 28: The method of Clause 27, wherein the system information comprises: an indication of one or more random access configurations, each of the one or more random access configurations comprising respective one or more random access preambles and respective one or more random access occasions.

Clause 29: The method of Clause 28, further comprising: receiving a first random access preamble on a first random access occasion, wherein: the respective one or more random access preambles, of a first random access configuration of the one or more random access configurations, comprises the first random access preamble; and the respective one or more random access occasions, of the first random access configuration, comprises the first random access occasion.

Clause 30: The method of Clause 28, wherein the one or more random access configurations are associated with the one or more applicable features.

Clause 31: The method of Clause 28, wherein: at least a first random access configuration, of the one or more random access configurations, is associated with the one or more applicable features; and at least a second random access configuration, of the one or more random access configurations, is not associated with the one or more applicable features.

Clause 32: The method of Clause 28, wherein: receiving the WUS comprises receiving the WUS in a time period; the WUS is based on a WUS preamble; and the system information comprises an indication of an association between a first random access configuration, of the one or more random access configurations, and a combination of a first WUS preamble and a first time period.

Clause 33: The method of Clause 32, wherein: the first WUS preamble comprises the WUS preamble; and the first time period comprises the time period.

Clause 34: The method of Clause 32, wherein: none of the one or more random access configurations is associated with the combination of the WUS preamble and the time period; and the one or more random access configurations comprise a common random access configuration.

Clause 35: The method of any one of Clauses 27-34, further comprising: sending DCI comprising an indication of one or more time-frequency resources for communication of the system information.

Clause 36: The method of Clause 35, wherein: the WUS is based on a WUS preamble; and the DCI comprises an indication of the WUS preamble.

Clause 37: The method of Clause 35, wherein: the WUS is based on a WUS preamble; the DCI comprises an acknowledgement of the WUS; and the system information is scrambled with an indication of the WUS preamble.

Clause 38: The method of Clause 35, wherein: the WUS comprises message one of a four-step random access procedure; the DCI comprises message two of the four-step random access procedure; and the system information comprises message three of the four-step random access procedure.

Clause 39: The method of any one of Clauses 27-37, wherein: the WUS comprises message A of a two-step random access procedure; and the system information comprises message B of the two-step random access procedure.

Clause 40: The method of Clause 39, wherein: the WUS is based on a WUS preamble; the message A comprises the indication of the one or more applicable features of the apparatus; and the indication of the one or more applicable features of the apparatus comprises one or more preambles associated with the one or more applicable features.

Clause 41: The method of any one of Clauses 27-40, further comprising: sending an indication of a WUS configuration, the WUS configuration comprising: an indication of one or more WUS preambles available for communication of the WUS; and an indication of one or more time frequency resources available for communication of the WUS.

Clause 42: The method of any one of Clauses 27-41, wherein the one or more applicable features of the UE comprise one or more of: reduced capability; small data; enhanced reduced capability; network slice AS group; message 3 repetition; or message 1 repetition.

Clause 43: A method for wireless communications by an apparatus comprising: receiving, in a time period, a WUS, wherein the WUS is based on a WUS preamble, the WUS comprising an indication of a request for system information; and receiving, after the WUS is sent, the system information, the system information comprising: an indication of one or more random access configurations; and an indication of an association between a first random access configuration, of the one or more random access configurations, and a combination of a first WUS preamble and a first time period.

Clause 44: The method of Clause 43, wherein: the first WUS preamble comprises the WUS preamble; and the first time period comprises the time period.

Clause 45: The method of any one of Clauses 43-44, wherein: none of the one or more random access configurations is associated with the combination of the WUS preamble and the time period; and the one or more random access configurations comprise a common random access configuration.

Clause 46: The method of any one of Clauses 43-45, wherein each of the one or more random access configurations comprises respective one or more random access preambles and respective one or more random access occasions.

Clause 47: The method of Clause 46, further comprising: receiving a first random access preamble on a first random access occasion, wherein: the respective one or more random access preambles, of a random access configuration of the one or more random access preambles, comprise the first random access preamble; and the respective one or more random access occasions, of the random access configuration, comprise the first random access occasion.

Clause 48: The method of any one of Clauses 43-47, further comprising: sending DCI comprising an indication of one or more time-frequency resources for communication of the system information.

Clause 49: The method of Clause 48, wherein: the DCI comprises an indication of the WUS preamble.

Clause 50: The method of Clause 48, wherein: the DCI comprises an acknowledgement of the WUS; and the system information is scrambled with second indication of the WUS preamble.

Clause 51: The method of Clause 48, wherein: the WUS comprises message one of a four-step random access procedure; the DCI comprises message two of the four-step random access procedure; and the system information comprises message three of the four-step random access procedure.

Clause 52: The method of any one of Clauses 43-51, further comprising: sending an indication of a WUS configuration, the WUS configuration comprising: an indication of one or more WUS preambles available for communication of the WUS; and an indication of one or more time frequency resources available for communication of the WUS.

Clause 53: One or more apparatuses, comprising: one or more memories comprising executable instructions; and one or more processors configured to execute the executable instructions and cause the one or more apparatuses to perform a method in accordance with any one of Clauses 1-52.

Clause 54: One or more apparatuses, comprising: one or more memories; and one or more processors, coupled to the one or more memories, configured to cause the one or more apparatuses to perform a method in accordance with any one of Clauses 1-52.

Clause 55: One or more apparatuses, comprising: one or more memories; and one or more processors, coupled to the one or more memories, configured to perform a method in accordance with any one of Clauses 1-52.

Clause 56: One or more apparatuses, comprising means for performing a method in accordance with any one of Clauses 1-52.

Clause 57: One or more non-transitory computer-readable media comprising executable instructions that, when executed by one or more processors of one or more apparatuses, cause the one or more apparatuses to perform a method in accordance with any one of Clauses 1-52.

Clause 58: One or more computer program products embodied on one or more computer-readable storage media comprising code for performing a method in accordance with any one of Clauses 1-52.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories comprising processor-executable instructions; and
one or more processors configured to execute the processor-executable instructions and cause the apparatus to:
send a wake up signal (WUS), the WUS comprising:
an indication of one or more applicable features of the apparatus, the one or more applicable features associated with random access configuration; and
an indication of a request for system information; and
receive, after the WUS is sent, the system information.

2. The apparatus of claim 1, wherein the system information comprises:
an indication of one or more random access configurations, each of the one or more random access configurations comprising respective one or more random access preambles and respective one or more random access occasions.

3. The apparatus of claim 2, wherein the one or more processors are configured to execute the processor-executable instructions and cause the apparatus to:
send a first random access preamble on a first random access occasion, wherein:
the respective one or more random access preambles, of a first random access configuration of the one or more random access configurations, comprises the first random access preamble; and
the respective one or more random access occasions, of the first random access configuration, comprises the first random access occasion.

4. The apparatus of claim 2, wherein the one or more random access configurations are associated with the one or more applicable features.

5. The apparatus of claim 2, wherein:
at least a first random access configuration, of the one or more random access configurations, is associated with the one or more applicable features; and
at least a second random access configuration, of the one or more random access configurations, is not associated with the one or more applicable features.

6. The apparatus of claim 2, wherein:
to send the WUS, the one or more processors are configured to execute the processor-executable instructions and cause the apparatus to send the WUS in a time period;
the WUS is based on a WUS preamble; and
the system information comprises an indication of an association between a first random access configuration, of the one or more random access configurations, and a combination of a first WUS preamble and a first time period.

7. The apparatus of claim 6, wherein:
the first WUS preamble comprises the WUS preamble; and
the first time period comprises the time period.

8. The apparatus of claim 6, wherein:
none of the one or more random access configurations is associated with the combination of the WUS preamble and the time period; and
the one or more random access configurations comprise a common random access configuration.

9. The apparatus of claim 1, wherein the one or more processors are configured to execute the processor-executable instructions and cause the apparatus to:
receive downlink control information (DCI) comprising an indication of one or more time-frequency resources for communication of the system information.

10. The apparatus of claim 9, wherein:
the WUS is based on a WUS preamble; and
the DCI comprises an indication of the WUS preamble.

11. The apparatus of claim 9, wherein:
the WUS is based on a WUS preamble;
the DCI comprises an acknowledgement of the WUS; and
the system information is scrambled with an indication of the WUS preamble.

12. The apparatus of claim 9, wherein:
the WUS comprises message one of a four-step random access procedure;
the DCI comprises message two of the four-step random access procedure; and
the system information comprises message three of the four-step random access procedure.

13. The apparatus of claim 1, wherein:
the WUS comprises message A of a two-step random access procedure; and
the system information comprises message B of the two-step random access procedure.

14. The apparatus of claim 13, wherein:
the WUS is based on a WUS preamble;
the message A comprises the indication of the one or more applicable features of the apparatus; and
the indication of the one or more applicable features of the apparatus comprises one or more preambles associated with the one or more applicable features.

15. The apparatus of claim 1, wherein the one or more processors are configured to execute the processor-executable instructions and cause the apparatus to:
receive an indication of a WUS configuration, the WUS configuration comprising:
an indication of one or more WUS preambles available for communication of the WUS; and
an indication of one or more time frequency resources available for communication of the WUS.

16. The apparatus of claim 1, wherein the one or more applicable features of the apparatus comprise one or more of:
reduced capability;
small data;
enhanced reduced capability;
network slice access stratum (AS) group;
message 3 repetition; or
message 1 repetition.

17. An apparatus configured for wireless communications, comprising:
one or more memories comprising processor-executable instructions; and
one or more processors configured to execute the processor-executable instructions and cause the apparatus to:
receive a wake up signal (WUS), the WUS comprising:
an indication of one or more applicable features of a user equipment (UE), the one or more applicable features associated with random access configuration; and
an indication of a request for system information; and
send, after the WUS is received, the system information.

18. The apparatus of claim 17, wherein the system information comprises:
an indication of one or more random access configurations, each of the one or more random access configurations comprising respective one or more random access preambles and respective one or more random access occasions.

19. The apparatus of claim 18, wherein the one or more processors are configured to execute the processor-executable instructions and cause the apparatus to:
receive a first random access preamble on a first random access occasion, wherein:
the respective one or more random access preambles, of a first random access configuration of the one or more random access configurations, comprises the first random access preamble; and
the respective one or more random access occasions, of the first random access configuration, comprises the first random access occasion.

20. The apparatus of claim 18, wherein the one or more random access configurations are associated with the one or more applicable features.

21. The apparatus of claim 18, wherein:
at least a first random access configuration, of the one or more random access configurations, is associated with the one or more applicable features; and
at least a second random access configuration, of the one or more random access configurations, is not associated with the one or more applicable features.

22. The apparatus of claim 18, wherein:
to receive the WUS, the one or more processors are configured to execute the processor-executable instructions and cause the apparatus to receive the WUS in a time period;
the WUS is based on a WUS preamble; and
the system information comprises an indication of an association between a first random access configuration, of the one or more random access configurations, and a combination of a first WUS preamble and a first time period.

23. The apparatus of claim 22, wherein:
the first WUS preamble comprises the WUS preamble; and
the first time period comprises the time period.

24. The apparatus of claim 17, wherein the one or more processors are configured to execute the processor-executable instructions and cause the apparatus to:
send downlink control information (DCI) comprising an indication of one or more time-frequency resources for communication of the system information.

25. The apparatus of claim 24, wherein:
the WUS is based on a WUS preamble; and
the DCI comprises an indication of the WUS preamble.

26. The apparatus of claim 24, wherein:
the WUS is based on a WUS preamble;
the DCI comprises an acknowledgement of the WUS; and
the system information is scrambled with an indication of the WUS preamble.

27. The apparatus of claim 24, wherein:
the WUS comprises message one of a four-step random access procedure;
the DCI comprises message two of the four-step random access procedure; and
the system information comprises message three of the four-step random access procedure.

28. The apparatus of claim 17, wherein:
the WUS comprises message A of a two-step random access procedure; and
the system information comprises message B of the two-step random access procedure.

29. A method for wireless communications by an apparatus comprising:
sending a wake up signal (WUS), the WUS comprising:
an indication of one or more applicable features of the apparatus, the one or more applicable features associated with random access configuration; and
an indication of a request for system information; and
receiving, after the WUS is sent, the system information.

30. A method for wireless communications by an apparatus comprising:
receiving a wake up signal (WUS), the WUS comprising:
an indication of one or more applicable features of a user equipment (UE), the one or more applicable features associated with random access configuration; and
an indication of a request for system information; and
sending, after the WUS is received, the system information.
